(19) United States
(12) Patent Application Publication
(10) Pub. No.: US 2026/0341256 A1
(43) Pub. Date: Oct. 29, 2026

(54) SYSTEMS, METHODS, AND COMPUTER-READABLE MEDIA FOR INTERACTIVE SPATIAL AUDIO SING-ALONG AND INSTRUMENT PERFORMANCE

(71) Applicant: Adeia Guides Inc., San Jose, CA (US)

(72) Inventors: Charles Dasher, Lawrenceville, GA (US); Reda Harb, Saint Petersburg, FL (US); Jean-Yves Couleaud, Mission Viejo, CA (US)

(21) Appl. No.: 19/190,175

(22) Filed: Apr. 25, 2025

(51) Int. Cl. G10H 1/36; G10H 1/00; G10H 1/46; H04S 7/00

(52) U.S. Cl. CPC G10H 1/361; G10H 1/0008; G10H 1/46; H04S 7/30; G10H 2210/005; G10H 2220/116; G10H 2240/075; H04S 2400/11

(57) ABSTRACT

Audio content may be dynamically modified based on user input. An example method includes receiving user voice data, determining that the user voice data corresponds to a vocal stem of a currently playing audio content item, and causing modification of the play of the content item. A second example method including receiving a user gesture performed using a finger, hand or arm, determining that the user gesture corresponds to the movement associated with an instrument stem of the playing content item, and causing modification of the play of the content item.

### BACKGROUND

The present disclosure relates to modifying audio content and, more particularly, to dynamically modifying audio content based on user input.

### SUMMARY

Complex studio equipment is often used to mix and manipulate audio tracks and audio stems (e.g., individual musical elements comprising one or more audio tracks that are layered together to create a final audio track), for example, in a studio recording session of a musical composition. A technological problem with such equipment is that audio engineering equipment may be complex, not intuitive, and may not be responsive to spontaneous, real-time user input.

A related technological problem is that a system that controls playback of a musical recording that has been disseminated to the public may fail to adapt in real time to user responses and performances. For example, an audio device may continue to play loudly and drown out the voice of a user trying to sing nearby and thus prevent her from properly hearing her own voice. Or, an audio device may continue to play without responding to a user nearby playing “air guitar” or “air drums.”

In some approaches, a karaoke audio recording includes instrumental tracks but not a lead vocal track. However, a karaoke audio recording will fail to provide the lead vocal track even if at some points in time this may be desired, and, more generally, a karaoke audio recording is unresponsive to the performances or other actions of users.

A technological solution according to some embodiments of the present disclosure is a system that, in response to detection of a voice input from a user singing while a prerecorded audio performance is being played, may dynamically transition to a “sing-along” mode (e.g., without requiring manual activation). To determine that the voice input received from a user corresponds to the song or other prerecorded audio performance being played, a system may retrieve and analyze metadata associated with the prerecorded audio performance. For example, the metadata may include phonetic alphanumeric representation of lyrics, audio representation phonemes corresponding to the lyrics, melody, rhythm and/or tempo, along with the timing of the lyrics and/or the melody, rhythm and/or tempo with respect to the playtime of the prerecorded audio performance. In some embodiments, a system may include a verification step prior to voice input metadata analysis. This verification step may comprise an initiation command (e.g., wake word, wake term, key press, gesture, or any other suitable input signal or combination thereof) to conduct preliminary analysis to determine that a user is approximating the lyrics or otherwise attempting to produce sounds aligned with the song being played. The system may monitor for a wake word verification, with which the system may recognize that a user is initializing a sing-along or other system mode (e.g., air play mode, conductor mode, duet mode, band mode, remote collaboration mode, synchronized exploration mode, streaming platform effects mode, etc.). In another example, the system may employ an initial analysis process with lower computational requirements to verify a user is singing. For instance, the system may differentiate between speech and singing by determining the timing of syllables and/or sustained or melodic pitches of the voice input corresponds to singing. In some embodiments, the system may access a local or remote data structure, such as a lookup table (LUT) to attempt to associate real-time user audio with stored lyric data and/or melody, rhythm and/or tempo data. One or more data structures that store such lyric data and/or melody, rhythm and/or tempo data may be searched in as needed in real time or may be accessed in a predetermined location. By employing techniques such as natural language processing (NLP) for phoneme matching, melody alignment using pitch detection, and rhythm synchronization with beat-tracking algorithms, the system may calculate a confidence score to confirm singing activity corresponding to a vocal track or stem of the prerecorded audio performance. While sometimes referred to as a prerecorded audio performance, it will be understood that the performance may incorporate prerecorded video content (e.g., concert footage or a music video) and/or may be a live performance or content. For example, the system may detect that a person is singing along with a concert located near the person or located remotely (e.g., streaming via a data network or received as a radio frequency transmission, such as a broadcast). Similarly, the system may detect that a person is playing air guitar, air drums or simulating the playing of other instruments, or simulating conducting while listening to a concert located near the person or located remotely.

If the system determines a correspondence between the voice data received and the lyrics and/or the melody, rhythm and/or tempo of the prerecorded audio performance being played, then in response the system may suppress (e.g., mute or decrease the volume of) a lead vocal stem and/or other vocal stems of the prerecorded audio performance. In some embodiments, in response, the system may spatially redistribute instrumental components of the audio to enhance the “sing-along” experience. In some embodiments, in response, the system may introduce audio effects for the voice data of the user (e.g., add reverb for ballads or echo for psychedelic tracks). In some embodiments, in response, the system may display lyrics of the song in time with the song.

A further technological solution is a system that may detect a user simulating the playing of an instrument, for example, a user playing air guitar or air drums, and may dynamically transition to an “air-play” mode. The system may detect gestures by tracking hand or hands, arm, or head movements, using one or more wearable sensors, such as a smartwatch, smart ring(s), or the motion of a smartphone held by a user, and/or using one or more cameras. In response, the system may adjust playback and spatial positioning of audio stems. For example, if the system detects that a user is simulating bowing a violin or strumming a guitar, then the system may center the violin stem or guitar stem with respect to other audio stems, increase the volume of the violin stem or guitar stem, or otherwise manipulate audio settings or audio effects to make the violin stem or guitar stem more prominent than before the detection of the simulated violin or guitar playing. In some embodiments, when the system determines that the user has stopped simulated violin or guitar playing, then it may restore the violin stem or guitar stem to the previous setting and/or volume. In some embodiments, the system may determine that a user has transitioned from using one air instrument to another and transition control of the instrument stems dynamically based on the air instrument currently being played.

Also contemplated are embodiments in which the system may detect musical instrumental audio received from the user or user device and modify the audio based on the musical instrumental audio. For example, the user may play a keyboard to produce the same or similar notes, chords and/or beats, or the like as those of, for example, a guitar instrument stem of the prerecorded performance or a portion thereof. In response to detecting such a match, the system may suppress (e.g., lower the volume, mute, etc.) the corresponding instrument stem that matches similar notes, chords and/or beats, suppress the corresponding matching instrument stem (e.g., keyboard playing replaces keyboard stem), adjust one or more other stems of the content item to match the octave or key adjustments, and/or adjust spatial arrangement according to the location of the corresponding stem.

In some embodiments, the system may cause suppression of the lead vocal stem for one device, for example, for the headphones of the user from whom the system detected the voice data, but not cause suppression of the lead vocal stem for one or more other devices. By way of further example, users may collaborate in a duet mode: the system may suppress the lead vocal stem for a first device used by a first singing user (e.g., suppress for the headphone worn by the first user) and enable playing audio based on the voice data from the first user for the first device, while the system may also suppress the lead vocal stem for a second device used by a second singing user (e.g., suppress for the headphone worn by the second user) but enable playing the audio based on the voice data from the second user for the second device. The first and second users may be physically located in the same space or may be located remote from each other.

A further technological solution is a system that may combine solutions contemplated for “sing-along mode” and “air-play mode” into a collaborative environment, or “band mode,” where the system may integrate one or more users playing an air-instrument and/or one or more users singing into one spatially arranged content item for playback in real time. For example, the system may receive a first user selection to air-play the drums, a second user selection to air-play the guitar and a third user selection to perform the vocals, in which each user may be co-located or remote, and modifies the spatial audio output similarly to “sing-along mode” and “air-play mode.” In some embodiments, band mode may be configured to be in a practice mode where the playback speed of an audio stem is based on the air-play rhythm of a user. In remote collaboration mode, the system may facilitate real-time recording with low-latency transmission and processing of the voice of the user, thus seamlessly integrating audio of all user selected stems with the spatial audio playback for all users. In some embodiments, for example, where the system determines that transmission latency exceeds an acceptable threshold, the system may store the session in the cloud, thus enabling playback and review at a later time. In some embodiments, for any system mode (e.g., sing along mode, air play mode, conductor mode, duet mode, band mode, remote collaboration mode, synchronized exploration mode, streaming platform effects mode, etc.), the system may store each participant's contribution in the cloud separately and/or together for editing, playback, or sharing after the session.

Also contemplated are embodiments in which the system provides a synchronized exploration mode, or “fly-by” mode, that allows a user to experience spatial position of audio stems such that the positioning simulates movement of the user through an audio landscape, for example, an orchestra. In some embodiments, synchronized exploration mode follows a pre-arranged spatial “flight path.” In the pre-arranged flight mode of synchronized exploration mode, the system may synchronize spatial audio adjustments with the temporal progression of the content item. For example, the system may begin playback of the orchestral content item with the spatial audio perspective heard as if the user were standing at the conductor's podium, and the pre-arranged flight path may transition the user's spatial audio perspective from one section to another section based on the focus or key elements of the orchestral content item being played. In some embodiments, synchronized exploration mode may be explored or accessed using interactive user controls received via earbuds, wearable sensors and/or a user device in a user controlled flight mode. For example, the user may move their hand or head as if flying or moving through stringed instruments on a left side of an orchestra and then move the hand or head right to move through the horn section. The system would increase the volume and/or spatially reposition the sound to provide the effect of being in the respective instrument section. For example, during Tchaikovsky's “Nutcracker Suite,” the user might transition from the celesta to the brass section, with spatial audio dynamically adjusted to make more prominent and/or to center the instrument section where the user is currently “located” based on the simulated flyby. In some embodiments, the user may simulate conducting the orchestra by movement of one or both hands to cause the system to enable greater prominence to the section of the orchestra indicated by the conductor. In some embodiments, the system may modify the timing of one or more audio stems in response to the simulated conductor hand or head movements.

Such a system may be configured using a companion application on one or more user devices or integrated with a streaming platform. For example, the companion application may be used to design the spatial arrangement of the musical stems of the content item, adjust confidence thresholds for stem detection, apply special effects, manage gesture controls, assign a gesture to a specific stem, calibrate the sensor detection of movements for head tracking and motion detection, select system modes, generate stems for a content item, select a content item with audio stems for playback, and/or select a predefined or user-defined audio role.

A method, system, non-transitory computer-readable medium, and means for implementing the method are disclosed for modifying audio content. Such a system may receive user voice data while a prerecorded audio performance comprising a plurality of audio stems is being played, determine that the user voice data corresponds to a vocal stem of the plurality of audio stems of the prerecorded audio performance, and, based on the user voice data corresponding to the vocal stem of the prerecorded audio performance, cause modification of the play of the prerecorded audio performance and cause play of audio based on the user voice data.

Such a system may be configured to retrieve metadata associated with the prerecorded audio performance and determine that speech data detected, based at least in part on the user voice data, corresponds to a lyrics data set of the metadata associated with the prerecorded audio performance.

Also contemplated is a system that may retrieve metadata associated with the prerecorded audio performance and determine that one or more of pitch data, beat data, or tempo data detected, based at least in part on the user voice data, correspond to a data set of the metadata associated with the prerecorded audio performance.

The modification of the audio content may comprise:
adjusting output of two or more instrument stems of the plurality of audio stems of the prerecorded audio performance being played such that the audio based on the user voice data is caused to be played spatially centered between the two or more instrument stems of the prerecorded audio performance;
adjusting sound spatialization of instrumental stems of the plurality of audio stems of the prerecorded audio performance; and/or
reducing a volume of the vocal stem of the prerecorded audio performance.

The system may determine cessation of receipt of the user voice data while the prerecorded audio performance is being played with the modification and, based at least in part on the determining the cessation of the receipt of the user voice data, increase the volume of the vocal stem of the prerecorded audio performance, or return the volume of the vocal stem to the original setting or a default setting, while other audio stems of the plurality of audio stems of the prerecorded audio performance continue to be played.

Such a system may cause the modification of the audio content at a first device, and simultaneously cause play of the audio content without the modification of the audio content at a second device.

Such a system may be configured to receive a graphical user interface (GUI) request for adjusting at least one of a spatial arrangement of an instrument stem of the prerecorded audio performance, a volume of the instrument stem of the prerecorded audio performance, or an audio effect for the instrument stem of the prerecorded audio performance. And, after receiving adjustments for audio parameters, the system may cause modification of the play of the prerecorded audio performance based at least in part on the adjusting.

Also contemplated is a system that may receive an indication of a user arm gesture while a prerecorded audio performance, comprising a plurality of audio stems, is being played. The system may determine that the indication of the user arm gesture corresponds to a musical pattern associated with a first instrument stem of the plurality of audio stems of the prerecorded audio performance, for example, a guitar strumming gesture. Based at least in part on the system determining that the indication of the user arm gesture corresponds to the musical pattern associated with the first instrument stem, the system may cause an increase in prominence of output of the first instrument stem with respect to at least one second audio stem of the plurality of audio stems of the prerecorded audio performance.

The system may determine that the indication of the user arm gesture is no longer being detected and cause the restoration of output of the first instrument stem to a setting before the causing of the increase in prominence of the first instrument stem while the prerecorded audio performance continues to be played.

Such a system may be configured to determine that the indication of the user arm gesture corresponds to the first instrument stem by determining that the indication of the user arm gesture corresponds to one of an air guitar gesture profile, an air drum gesture profile, an air saxophone gesture profile, or an air trumpet gesture profile.

The system may adjust a spatial arrangement of a second audio stem and a third audio stem of the plurality of audio stems of the prerecorded audio performance such that output of the first instrument stem is caused to be played spatially centered between the second audio stem and the third audio stem.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 illustrates an example of suppressing a vocal stem of a prerecorded audio performance and including audio based on the user voice data, according to an example of an aspect of some embodiments of the present disclosure;

FIG. 2 illustrates an example of a spatial audio layout of prerecorded audio stems during a vocal stem modification of the prerecorded audio, according to an example of an aspect of some embodiments of the present disclosure;

FIG. 3 illustrates an example of modifying an instrument stem of a prerecorded audio performance based on the user gesture data, according to an example of an aspect of some embodiments of the present disclosure;

FIG. 4 illustrates an example of a spatial audio layout of prerecorded audio stems during an instrument stem modification of the prerecorded audio, according to an example of an aspect of some embodiments of the present disclosure;

FIG. 5 illustrates an example system architecture for interactive spatial audio sing-along and instrument performance, according to an example of an aspect of some embodiments of the present disclosure;

FIG. 6 illustrates an example of metadata of a prerecorded audio performance, according to an example of an aspect of some embodiments of the present disclosure;

FIG. 7 is a sequence diagram for sing-along mode, according to an example of an aspect of some embodiments of the present disclosure;

FIG. 8 illustrates an example of a user interface to customize the spatial audio layout of prerecorded audio stems, according to an example of an aspect of some embodiments of the present disclosure;

FIG. 9 is a sequence diagram for spatialization of audio stems, according to an example of an aspect of some embodiments of the present disclosure;

FIG. 10 is a sequence diagram for applying vocal effects to audio input, according to an example of an aspect of some embodiments of the present disclosure;

FIG. 11 is a sequence diagram for audio control, according to an example of an aspect of some embodiments of the present disclosure;

FIG. 12 illustrates an example of a synchronized exploration mode, according to an example of an aspect of some embodiments of the present disclosure;

FIG. 13 is a sequence diagram for synchronized exploration mode, according to an example of an aspect of some embodiments of the present disclosure;

FIG. 14 illustrates an example of a duet mode, according to an example of an aspect of some embodiments of the present disclosure;

FIG. 15 is a sequence diagram for band mode, according to an example of an aspect of some embodiments of the present disclosure;

FIG. 16 is a sequence diagram for remote collaboration mode, according to an example of an aspect of some embodiments of the present disclosure;

FIG. 17 is a sequence diagram for streaming platform effects mode, according to an example of an aspect of some embodiments of the present disclosure;

FIG. 18 is a flowchart that illustrates a process for modifying a prerecorded audio performance based on corresponding user voice data, according to an example of an aspect of some embodiments of the present disclosure;

FIG. 19 is a flowchart that illustrates a process for modifying a prerecorded audio performance based on corresponding user gesture data, according to an example of an aspect of some embodiments of the present disclosure;

FIG. 20 depicts illustrative user equipment, in accordance with some embodiments of this disclosure; and

FIG. 21 depicts an illustrative user equipment system, in accordance with some embodiments of this disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting exemplary embodiments and that the scope of the present invention is defined solely by the claims.

### DETAILED DESCRIPTION

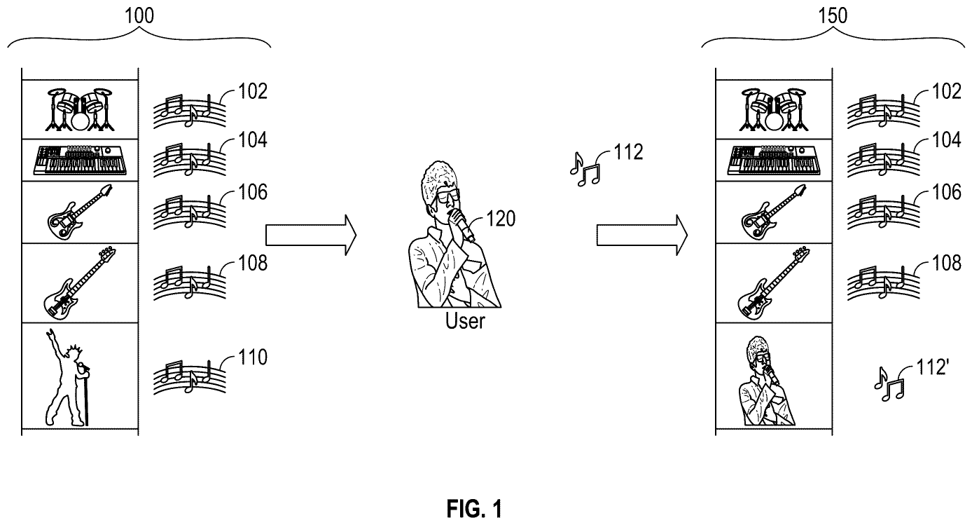

FIG. 1 illustrates an example of suppressing a vocal stem of a prerecorded audio performance and including audio based on the user voice data, according to an example of an aspect of some embodiments of the present disclosure. In some embodiments, content item 100 includes a plurality of audio stems. For example, content item 100 may comprise drum stem 102, keyboard stem 104, guitar stem 106, bass stem 108, and vocal stem 110. The system may monitor for voice input 112 through microphone 120 to modify the content item 100 and the spatial arrangement of content item 100 audio stems and thus generate modified content item 150 shown in FIG. 1. Thus, the system may create an immersive audio experience, making the user feel as though they are performing vocals with a live band.

For example, microphone 120 may be integrated into earbuds, speakers, a hands-free system of a vehicle, a phone, or any other suitable audio capture and/or audio playback device. In some embodiments, more than one microphone may be available for monitoring, and the system may select a microphone for monitoring based on the microphone capability (e.g., noise canceling) in the surrounding environment and/or connectivity. For example, in a vehicle connected to an entertainment device via software (e.g., via CarPlay, Android Auto, etc.), the system may prioritize the hands-free microphone of the vehicle over the microphone of the connected iPhone. In another example, the system may prioritize integrated microphones of active earbuds over a microphone of the connected phone that may be located farther away from the source of the voice input. In other scenarios, for example, where no additional hardware is connected to the phone, the phone microphone may be prioritized.

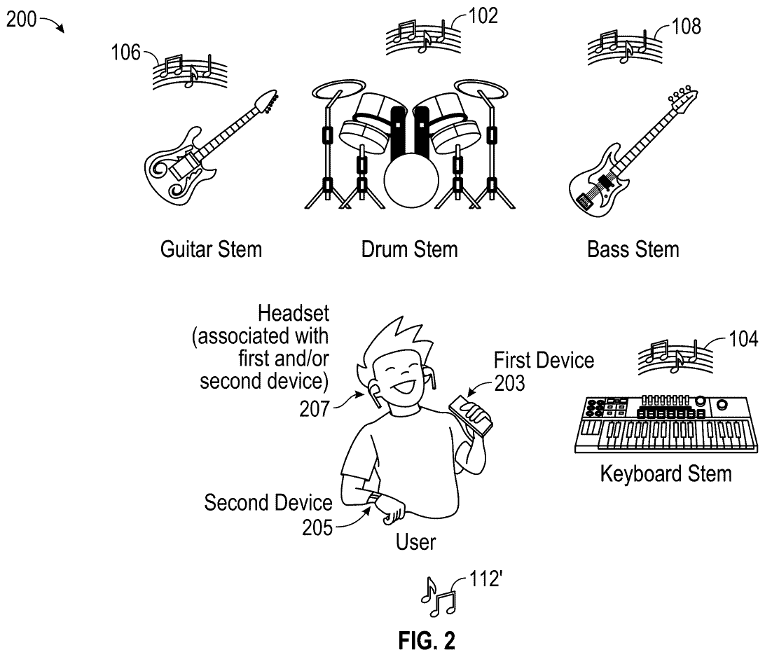

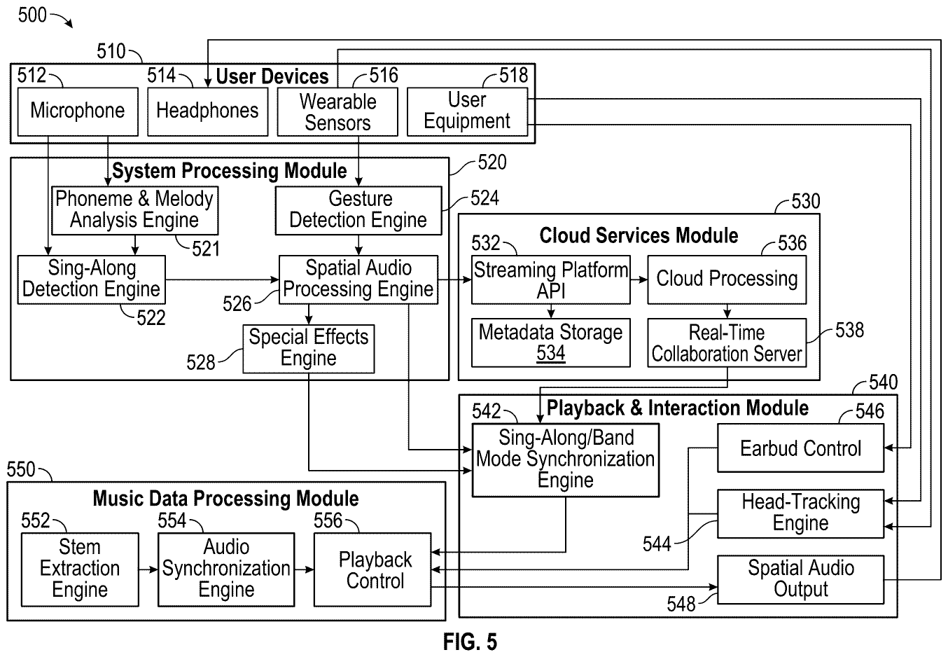

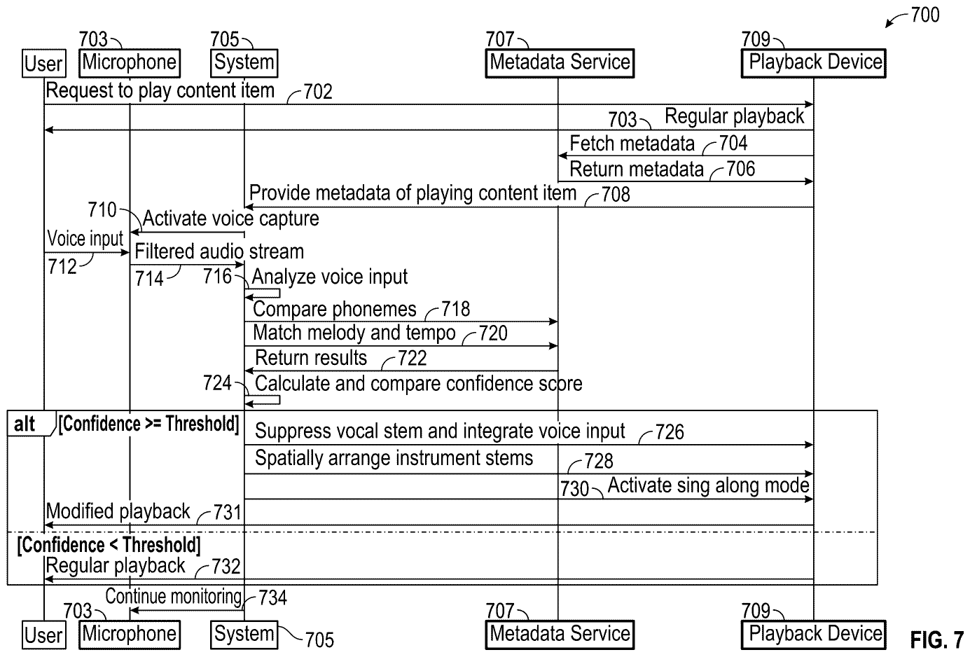

In some embodiments, for example, upon system determination that user voice input 112 corresponds to vocal stem 110 (e.g., via sing-along detection engine 522 of FIG. 5), the system may modify content item 100 to remove vocal stem 110, integrate audio based on the user voice data 112′ to generate modified content item 150, adjust the spatial arrangement of the audio stems of modified content item 150 (e.g., as illustrated in FIG. 2), and/or activate sing-along mode. In some embodiments, the system does not integrate audio based on the user voice data 112′. For example, the system may modify content item 100 to remove or reduce vocal stem 110 and allow the user to hear themselves sing without electronic assistance. Additional details of sing-along mode are provided through the descriptions of FIG. 7.

In some embodiments, the system may include a verification step prior to voice input metadata analysis. For example, the system may receive a wake word or term, for example, “Alright, mic check” and initialize sing-along mode. In another example, the system may, prior to the determination that user voice input 112 corresponds to vocal stem 110, determine that voice input 112 has syllabic timing that does not match a normal speech pattern (e.g., the user's speech pattern) and initiate metadata analysis to determine if user voice input 112 corresponds to vocal stem 110.

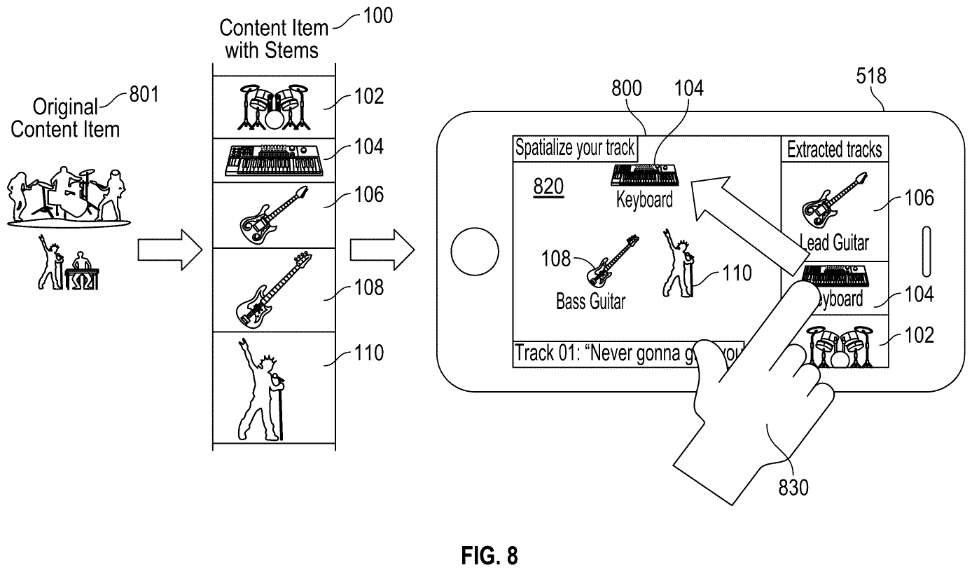

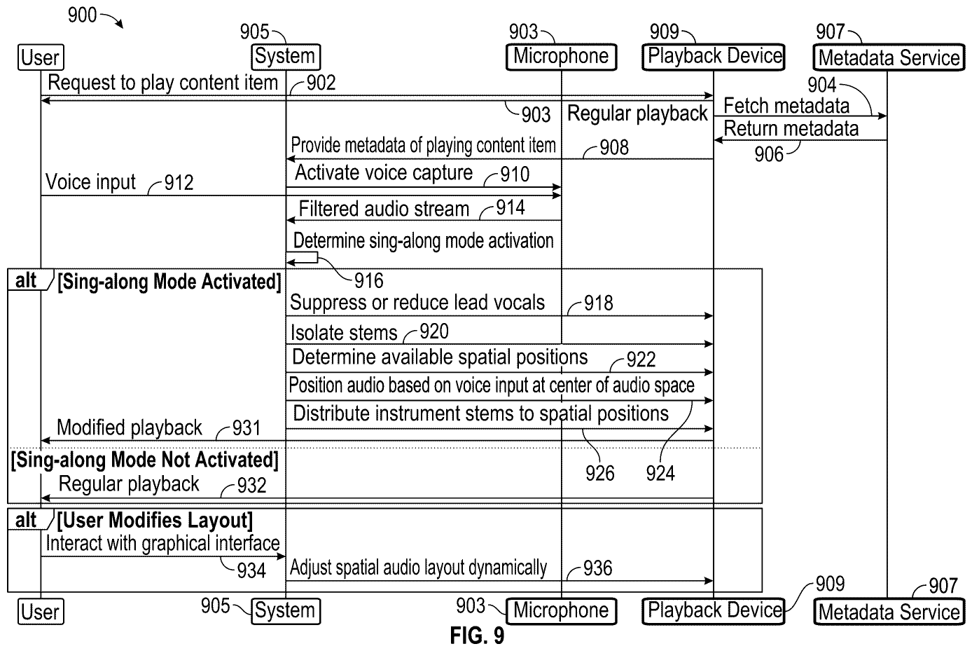

FIG. 2 illustrates an example of a spatial audio layout 200 of prerecorded audio stems (e.g., drum stem 102, keyboard stem 104, guitar stem 106, and bass stem 108) during a vocal stem modification of the prerecorded audio, according to an example of an aspect of some embodiments of the present disclosure. For example, the original spatial layout of the content item being played may have an audio stem that is not prominently provided or may have all audio stems spatially centered (e.g., collapsed stereo image). Upon system determination that a user voice input corresponds to a vocal stem (e.g., as detailed in FIG. 7), the system may create spatial audio layout 200 in which instrument stems (e.g., drum stem 102, keyboard stem 104, guitar stem 106, and bass stem 108) and audio based on the user voice data 112′ are spatially located so that the user perceives themself to be front and center of the band singing. In some embodiments, first device 203, second device 205, and/or headset 207 may comprise a microphone to receive user voice data and/or sensors to determine user gestures indicating an instrument stem being played and/or playback controls to modify the audio output. In some embodiments, spatial audio layout 200 may be configured through a companion application and modified throughout the session, as described in FIGS. 8 and 9. In some embodiments, for example, when the system determines that voice input 112 has stopped, the system may revert to playing the original content item with the original spatial layout.

In an automotive context, the system may determine in which seat or area of the vehicle the user is singing and may adjust vehicle speakers accordingly. For example, upon determining the voice input of the driver, in the front left of the vehicle, corresponds with the vocal stem of the content item being played, the system may adjust vehicle speakers to bias instrumental stems to the back and left of the vehicle to center the driver's perception of the audio without disturbing the driver's ability to navigate the road. In another example, upon determining the voice input of a backseat passenger, in the back right of the vehicle, corresponds with the vocal stem of the content item being played, the system may adjust vehicle speakers to bias instrumental stems to the back and right of the vehicle to center the passenger's perception of the audio. Upon determining two voice inputs corresponding with the vocal stem of the content item being played, the system may adjust vehicle speakers to bias instrumental stems between the determined locations of the two voice inputs. In some embodiments, the system may bias spatial location of the audio output according to voice commands, gestures, and/or adjustments made in the companion application.

In some embodiments, the system may detect multiple users singing and determine that a first user is singing, or attempting to sing, a lead vocal while one or more additional users are singing, or attempting to sing, a chorus, harmony or backup vocals, or that a single user may be singing, or attempting to sing, portions or all of the lead vocals and portions or all of the chorus, harmony of backup vocals. The system may then suppress the matched vocal stems of the prerecorded performance.

Also, while described herein sometimes as voice data, the user may be approximating instrumental sounds, such as by humming or singing portions corresponding to instrument stem portions of the prerecorded audio performance. The system may detect such user audio data and correlate it to data in the metadata or stored data structure. If a match is determined, the system may mute, lower the volume of, and/or otherwise make less prominent the matched one or more instrumental stems.

In some embodiments, the system may detect musical instrumental audio received from the user or user device. For example, the user may be playing a musical instrument audio (e.g., guitar, drums, keyboard, simulated guitar, etc.) similar to a musical instrument that was used to generate one or more instrument stems of the prerecorded performance, or the user may be playing a different musical instrument with the same or similar notes, chords and/or beats or the like as those of one or more instrumental stems of the prerecorded performance or a portion of one or more instrument stems of the prerecorded performance. For example, the user may play a keyboard to produce the same or similar notes, chords and/or beats or the like as those of a guitar instrument stem of the prerecorded performance or a portion thereof. The notes or chords may be detected to be in a different octave or key. In response to detecting such a match, the system may suppress (e.g., lower the volume, mute, etc.) the corresponding instrument stem that matches similar notes, chords and/or beats, suppress the corresponding matching instrument stem (e.g., keyboard playing replaces keyboard stem), adjust one or more other stems of the content item to match the octave or key adjustments, and/or adjust spatial arrangement according to the location of the corresponding stem. The companion application may be used to configure a selection default between suppression of the corresponding instrument stem that matches similar notes, chords and/or beats or suppression of the corresponding matching instrument stem.

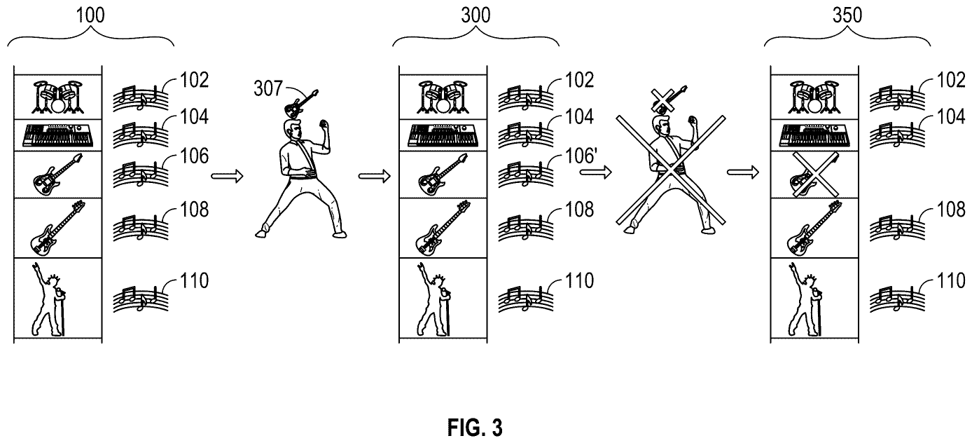

FIG. 3 illustrates an example of modifying an instrument stem of a prerecorded audio performance (sometimes referred to as content item) 100 based on the user gesture data, according to an example of an aspect of some embodiments of the present disclosure. In some embodiments, content item 100 includes a plurality of audio stems. For example, content item 100 may comprise drum stem 102, keyboard stem 104, guitar stem 106, bass stem 108, and vocal stem 110. The system may monitor for user gesture input 307 through a user device (e.g., user equipment 518 of FIG. 5), headset (e.g., headphones 514 of FIG. 5), and/or sensors (e.g., wearable sensors 516 of FIG. 5) to detect user simulation of a musical instrument, such air guitar or air drums. In response to determining a match of the simulated musical instrument and one or more instrument stems of the content item 100, for example, based on matching the user's hand or arm rhythm in “strumming” the air guitar matching guitar stem 106 or in “beating” drums matching drum stem 102, the system may modify the content item and the spatial arrangement of the content item audio stems. The system may amplify, spatially center, or otherwise make more prominent the corresponding instrument stem or stems (e.g., make the corresponding guitar stem of the prerecorded audio performance louder). If the system detects that the user has stopped the simulated musical instrument playing, for example, before the conclusion of the song or musical piece being played in the prerecorded content item 100, then the system may mute, suppress or otherwise render the corresponding instrument stem or stems (e.g., make the corresponding guitar stem of the prerecorded audio performance) less prominent for the remainder the song or musical piece or until the user resumes the simulation. In another example, if the system detects that the user has stopped the simulated musical instrument playing, the system may resume delivering unaltered audio with the default spatialization. Thus, the system may create an immersive audio experience, making the user feel as though they are performing with an instrument with a live band.

For example, the system may monitor (for example, using one or more cameras and/or sensors) for user gestures indicating an instrument stem of the content item is being mimicked while the content item is being played. In another example, the user may select an instrument stem to embody through the companion application, and the system may monitor for user gestures corresponding to the selected instrument stem to use for content item instrument stem modification. In some embodiments, the user gesture may comprise arm movements that an inertial measurement unit (IMU) (e.g., accelerometer, gyroscope, magnetometer, etc.) in the wearable device may detect. For example, the system may receive a user selection of the violin stem in the companion application, monitor for user gestures simulating bowing (e.g., arm movement back and forth), and modify the violin stem based on the determined user input gestures. Similarly, for example, the system may receive a user selection of the percussion stem in the companion application, monitor for user gestures simulating percussion instruments (e.g., rhythmic tapping for drums, shaking motions for tambourine, etc.), and modify the percussion stem based on the determined user input gestures. In some embodiments, the system modification of the content item based on the user input gestures includes modification to playback characteristics (e.g., volume, intensity, articulation) based on the speed, rhythm, and/or direction of the system-determined user input gestures and/or movement. For instance, upon determination of a violin stem, subsequent signals determined by the system may result in an increase of the intensity of the violin stem (e.g., in response to a fast bowing motion), or may result in softer, more nuanced tones (e.g., in response to subtle movements).

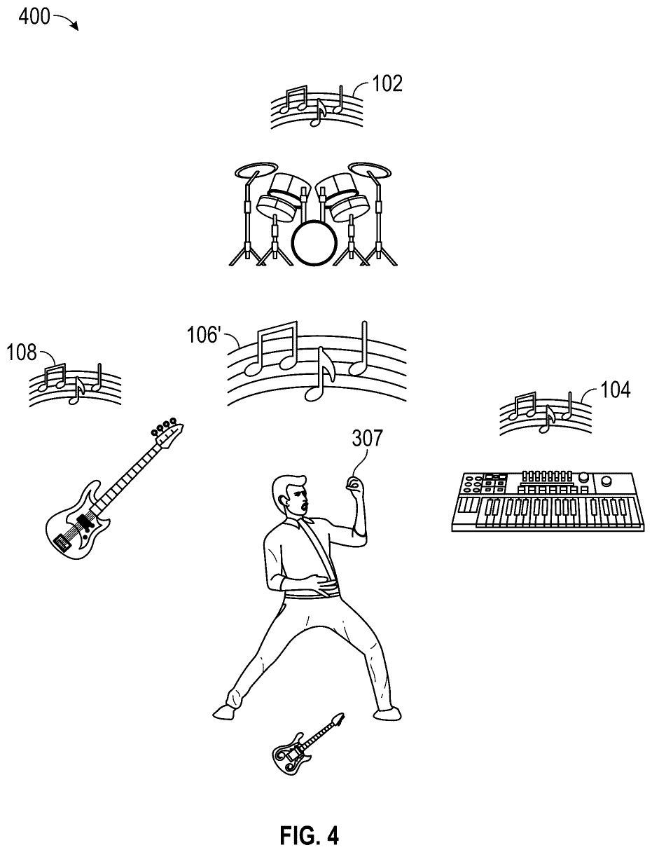

In some embodiments, for example, upon system determination that user gesture input 307 corresponds to guitar stem 106, the system may modify content item 100 to modify guitar stem 106 based on user gesture input 307 (e.g., played at the rate of the user's strumming), integrate modified guitar stem 106′ to generate modified content item 300, adjust the spatial arrangement of the audio stems of modified content item 300 (e.g., as illustrated in FIG. 4), and/or activate air-play mode. In some embodiments, instead of guitar stem 106 being modified based on the user gesture input 307, the system initiates guitar stem 106 output control based on whether or not the user gesture input 307 continues. For example, if user gesture input 307 stops, the guitar stem 106 would stop being output by the system.

In some embodiments, for example, upon system determination that user gesture input 307 being used to modify guitar stem 106 has stopped, the system may stop modified guitar stem 106′ and generate modified content item 350, adjust the spatial arrangement of the audio stems of modified content item 350, and/or deactivate air-play mode. In some embodiments, for example, when the system deactivates air-play mode, the system may revert to playing content item 100 with the original spatial layout.

In some embodiments, the system may monitor for user gestures indicating a conductor role while the content item is being played. In some embodiments, the user may select conductor mode through the companion application, and the system may monitor for user gestures corresponding to conductor movements to use for content item audio output modification. For example, the system may control the spatial audio mix of an orchestral content item by determining simulated conductor gestures and entering conductor mode. In some embodiments, for example, upon system determination that the user gestures indicating a conductor role have stopped, the system may deactivate conductor mode and revert to playing the original orchestral content item.

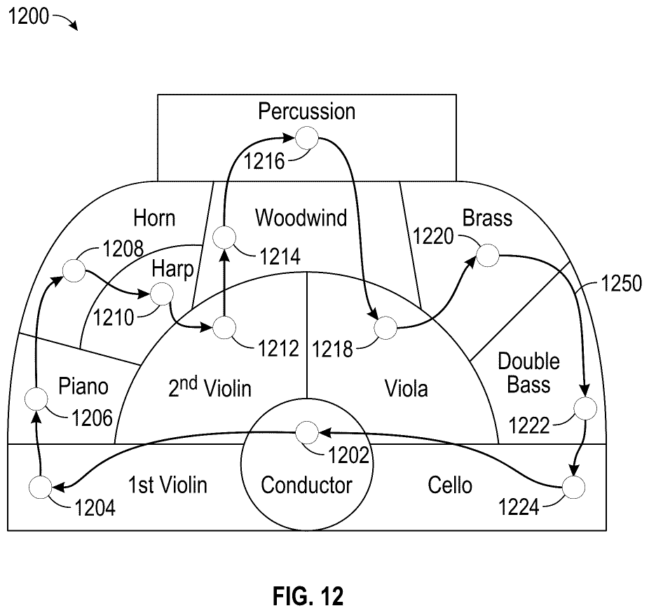

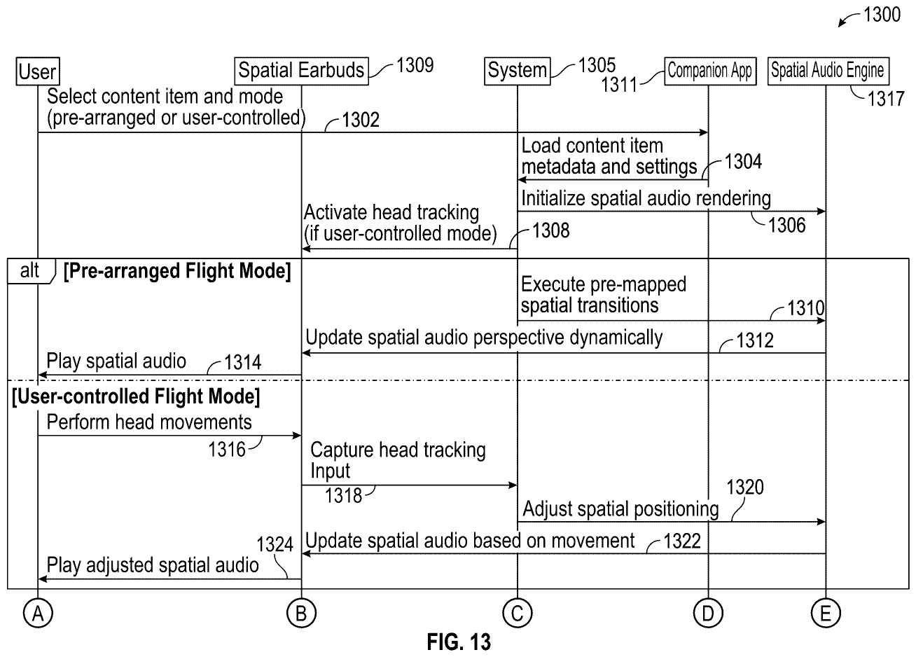

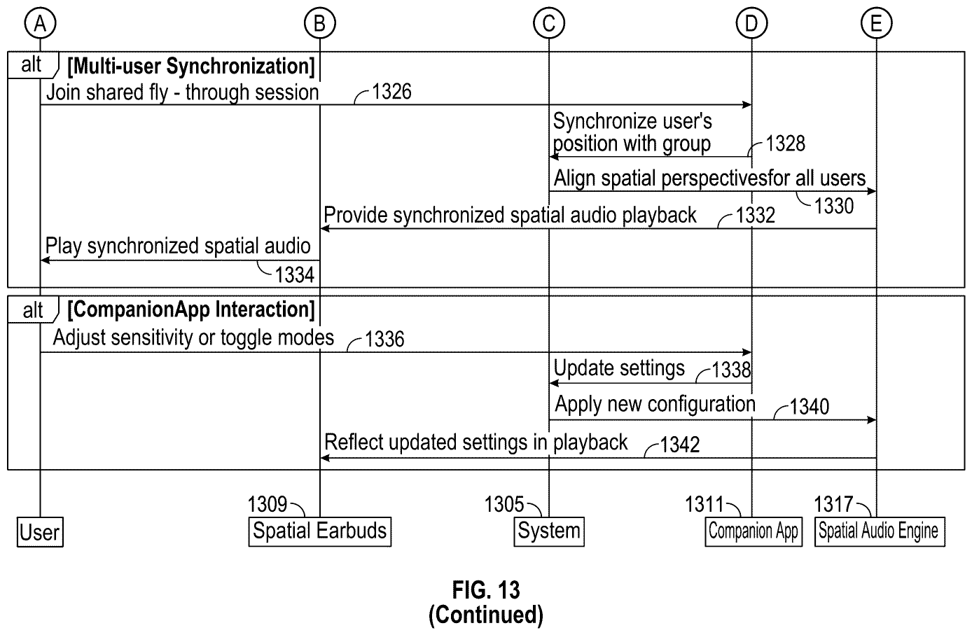

In some embodiments, the system may use head tracking (e.g., via sensors embedded in earbuds) to determine movements corresponding to spatial audio control of the content. For example, the system may determine that a head tilting up or down corresponds to adjusting the content item output volume up or down, respectively. In another example the system may determine a head turn left or right corresponds to adjusting the content item output to emphasize specific sections (e.g., stems) of the orchestra relative to the head-turn motion. For example, when the system determines that the user's head has turned toward the virtual location of the brass section, the system may increase the prominence of that stem (e.g., increase brass stem volume, and/or decrease other stem volume) in the spatial audio mix. In some embodiments, virtual location corresponds to the spatial audio location of audio stems heard by the user in stereo. The spatial audio locations of the instrument stems, in turn, may be mapped to various instrument sections of the orchestra layout on a stage. For example, as illustrated in audio spatial layout 1200 of FIG. 12, each stem (e.g., percussion, brass, harp, etc.) has a corresponding virtual area in audio spatial layout 1200 that serves as the spatial audio location (e.g., area, point, etc.) of that stem. For example, in user-controlled flight mode of synchronized exploration mode (further detailed in FIG. 13), the system, determining the user to be located at the virtual location of the viola section (e.g., node 1218 of FIG. 12), may map the head of a user turning to the right from the woodwind section to the brass section, thus increasing the prominence of the brass section and reducing the prominence of the woodwind section.

In some embodiments, the system may track arm, wrist, hand, and/or finger gestures (e.g., via wearable sensors 516 and/or user equipment 518 of FIG. 5) to determine movements corresponding to content spatial audio control. For example, the system may determine wrist movements corresponding to traditional conductor motions that cause the system to raise the intensity or slow the tempo of one or more orchestral stems. For instance, the system may trigger a crescendo when the system determines a quick upward flick of a wrist, or the system may slow the tempo when the system determines a downward motion of a wrist.

In some embodiments, when the system determines a change in voice input and/or gesture input, the system may dynamically transition between available stems according to the determined input (e.g., via gesture detection engine 524). For instance, the system may sense a change in voice input and/or gesture input, or the system may receive a role change through the companion application. For example, when the system determines that a guitar strumming gesture has stopped and a drumming motion has started, the system may stop or attenuate the guitar stem and start, emphasize, or modify the drum stem based on the determined movements.

FIG. 4 illustrates an example of a spatial audio layout 400 of prerecorded audio stems (e.g., drum stem 102, keyboard stem 104, and bass stem 108) during an instrument stem modification (e.g., modified guitar stem 106′) of the prerecorded audio, according to an example of an aspect of some embodiments of the present disclosure. For example, the original spatial layout of the content item being played may have had a lead vocal stem spatially centered, with instrument stems spatially located behind the lead vocal stem. Upon system determination that user gesture input 307 corresponds to guitar stem 106 (e.g., via gesture detection engine 524) or user selection of the guitar stem 106 via the companion application, the system may create spatial audio layout 400 in which modified guitar stem 106′ is centered and other stems are spatially located behind and around it. In this way, users may be aided in perceiving themself to be front and center of the band playing guitar, as illustrated in FIG. 4. In some embodiments, spatial audio layout 400 may be configured through a companion application and modified throughout the session, as described in FIGS. 8 and 9. In some embodiments, for example, when the system determines that user gesture 307 has stopped, the system may revert to playing the original content item with the original spatial layout.

In some embodiments, modified guitar stem 106′ may be substantially similar to guitar stem 106. In some embodiments, modified guitar stem 106′ may be modified based on the determined input gestures (e.g., the gestured rhythm, notes, chords, movement of the user, etc.). For example, when the system determines that the user is moving forward (e.g., any movement, such as stepping jumping, etc., toward the spatial audio location of the audio stem), the system may increase the prominence (e.g., increase modified guitar stem 106′ volume, and/or decrease other stem volume) of modified guitar stem 106′. In another example, when the system determines that the user gesture is faster than guitar stem 106, the system may increase the tempo of modified guitar stem 106′ and/or other stems.

FIG. 5 illustrates an example system architecture 500 for interactive spatial audio sing-along and instrument performance, according to an example of an aspect of some embodiments of the present disclosure. In some embodiments, the system may comprise, e.g., user devices 510, system processing module 520, cloud services module 530, playback & interaction module 540, and music data processing module 550. While sometimes described as a cloud services module 530, it will be understood that this and/or other modules may be provided locally or in a wide area network (WAN), for example, connected via Bluetooth or Wi-Fi, and that other modules may be provided in the cloud or provided locally or in a WAN, for example, connected via Bluetooth or Wi-Fi. In some embodiments, the user devices and modules of system architecture 500 transmit data using one or more low-latency communication protocols (e.g., WebRTC, QUIC, user datagram protocol (UDP)-based protocols optimized for minimal jitter and delay, etc.). In some embodiments, the system utilizes packet prioritization, adaptive bitrate encoding, and forward error correction to minimize disruptions in audio quality and reduce latency.

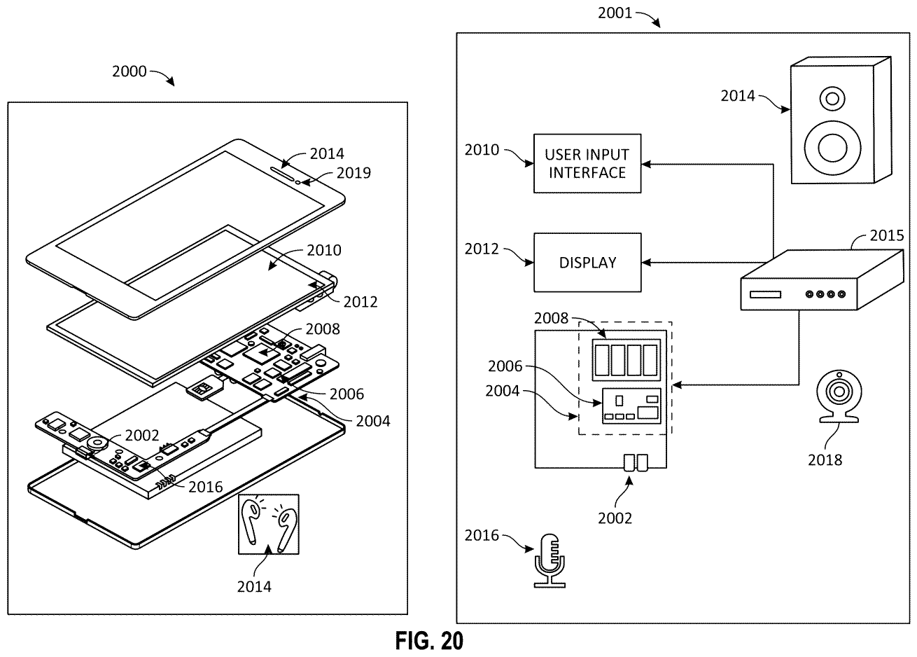

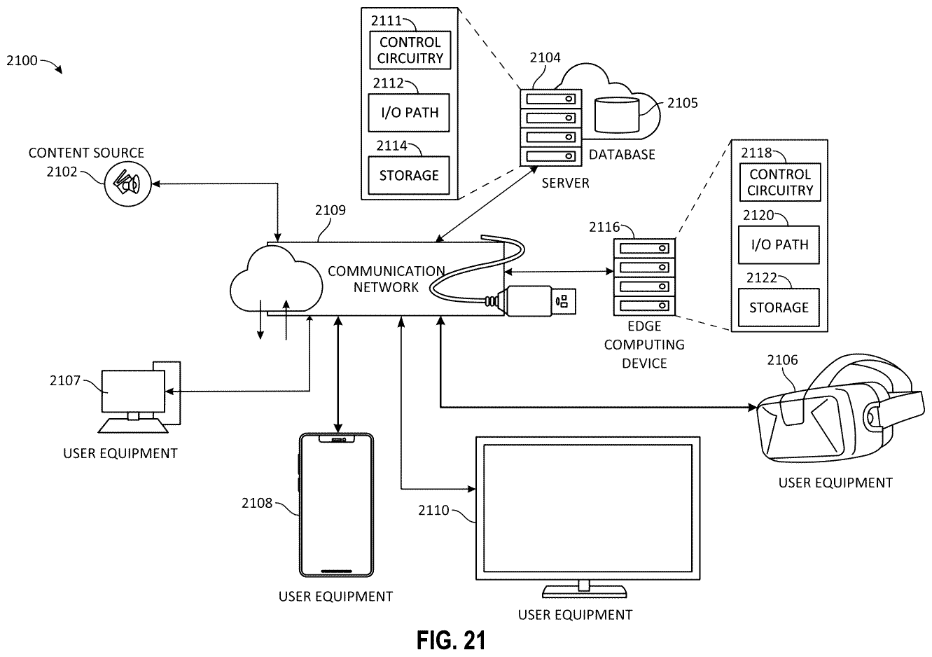

In some embodiments, user devices 510 may comprise, e.g., microphone 512, headphones 514, wearable sensors 516, and user equipment 518. Microphone 512 may comprise, for example, a dynamic microphone (e.g., microphone 120 of FIG. 1), a condenser microphone, a ribbon microphone, a microphone array with noise-canceling features and/or any other suitable microphone or combination thereof. In some embodiments, microphone 512 may be integrated into headphones 514 or user equipment 518. In some embodiments, the system control circuitry (e.g., control circuitry 2004 of FIG. 20 and/or control circuitry 2111 of FIG. 21), and/or I/O circuitry (e.g., I/O circuitry 2002 of FIG. 20 and/or I/O circuitry 2112 of FIG. 21) may filter the voice input to remove background noise, normalize the voice input in amplitude, and perform feature extraction (e.g., mel-frequency cepstral coefficients (MFCC), gamma-tone cepstral coefficients (GTCCs), etc.) to generate a speech-to-text output from the voice input for analysis. For example, the system control circuitry may apply noise-filtering techniques to isolate the voice of the user from environmental sounds. The system may dynamically apply a filtering method tailored to the surrounding environment. For example, in a vehicle, the system may apply adaptive noise cancellation to reduce road noise. In another example, in quieter settings, the system may apply simpler filtering methods to enhance the clarity of the vocal input. Headphones 514 may comprise, for example, circumaural (over-ear) headphones, supra-aural (on-ear) headphones, earbuds (e.g., headset 207 of FIG. 2), in-ear headphones, gaming headsets, noise-canceling headphones, speakers, soundbars, wireless audio devices, wired audio devices, and/or any other suitable audio device or combination thereof. Wearable sensors 516 may comprise, for example, electrodes, optical emitters and detectors, microphones, thermometers, thermistors, pressure sensors, respiratory sensors, eye-tracking sensors, video oculography (VOG) systems, facial tracking systems, infrared cameras, thermal cameras, motion sensors, accelerometers, global positioning systems (GPS), pulse oximeters, ultrasonic sensors, voice-prosody analyzers, or other suitable sensors, or any combination thereof. In some embodiments, the system control circuitry (e.g., control circuitry 2004 of FIG. 20 and/or control circuitry 2111 of FIG. 21), and/or I/O circuitry (e.g., I/O circuitry 2002 of FIG. 20 and/or I/O circuitry 2112 of FIG. 21) may filter the wearable sensor input to remove noise, normalize the signal, and perform feature extraction (e.g., movement signatures (e.g., strumming, bowing, note/cord fingering, conducting, fretting, drumming, etc.), movement speed, movement rhythm, movement direction, etc.). User equipment 518 may comprise, for example, an XR device (e.g., user equipment 2106 of FIG. 21), a personal computer (e.g., a notebook, a laptop, a tablet, a desktop, user equipment 2107 of FIG. 21), a smartphone (e.g., user equipment 2000 of FIG. 20, user equipment 2108 of FIG. 21), a smartwatch, a television (e.g., user equipment 2110 of FIG. 21), and/or any other suitable device or combination thereof (e.g., first device 203, second device 205, and headset 207 of FIG. 2).

In some embodiments, user equipment 518 comprises a companion application to configure and control settings of the system. For example, the companion application may be used to design the spatial arrangement of the musical stems of the content item (e.g., via user interface 800 of FIG. 8), adjust confidence thresholds for stem detection, apply special effects, manage gesture controls, assign a gesture to a specific stem, calibrate the sensor detection (e.g., sensitivity) of movements for head tracking and motion detection, select system modes, generate stems for a content item (e.g., via stem extraction engine 552), select a content item with audio stems for playback, and/or select a predefined or user-defined audio role.

In some embodiments, system processing module 520 may comprise, e.g., phoneme & melody analysis engine 521, sing-along detection engine 522, gesture detection engine 524, spatial audio processing engine 526, and special effects engine 528.

Phoneme & melody analysis engine 521 may comprise, for example, a natural language processing (NLP) artificial intelligence (AI) and/or other machine learning (ML) model trained on various vocal datasets to perform real-time audio analysis of a voice input for comparison with stored or retrieved metadata. For example, phoneme & melody analysis engine 521 may determine pitch, rhythm, tempo, beats per minute, and/or time signature of the voice input to compare against metadata of the content item that is playing. In some embodiments, phoneme & melody analysis engine 521 may analyze the voice input for alignment with segmentation metadata describing verses, choruses, and instrumental breaks of the playing content item. In some embodiments, the system may maintain a dictionary and/or database of analyzed voice inputs, outputs, and outcomes stored in a data structure in system memory (e.g., metadata storage 534, in storage circuitry 2008 of FIG. 20, storage circuitry 2114 of FIG. 21, or any other suitable storage) for refinement or retraining of the ML model.

Sing-along detection engine 522 may, for example, determine a confidence score corresponding to the similarity between the voice input and the content item being played and compare the confidence score to a predetermined confidence score threshold (e.g., 80% or a threshold between 51-99%) to determine whether the user is singing the lyrics of the content item. In some embodiments, sing-along detection engine 522 integrates multiple factors (e.g., phoneme similarity, melody alignment, tempo synchronization, etc.) to calculate a confidence score. In some embodiments, for example, if the combined score meets or exceeds a predetermined threshold (e.g., 85% or a threshold between 51-99%), sing-along detection engine 522 may determine that the user is singing, activate a sing-along mode, adjust the audio mix of the content item being played (e.g., spatially, audibly, etc.), and continue to process voice input for the audio mix adjustment. For example, the system may use determinations from sing-along detection engine 522 to activate sing-along mode, which may comprise suppressing or muting the vocal stem of the content item, integrating the voice input with the other stems of the content items, and/or spatially arranging the other stems of the content item according to the user being located where the vocal stem was located within the audio landscape. In some embodiments, sing-along detection engine 522 may determine that the audio input corresponding to the vocal stem has stopped, another selection for a different stem has been made, and/or another corresponding vocal stem has a confidence score above a predetermined confidence score threshold. Thus, output from sing-along detection engine 522 may be used to dynamically transition between manipulation of a plurality of vocal stems available for a content item. For instance, when sing-along detection engine 522 determines that a voice input corresponding to lead vocals has stopped and a voice input for secondary vocals has started, the system may restore the lead vocal stem and attenuate or mute the secondary vocal stem based on the determined voice input. In some embodiments, for example, if the combined score is below a predetermined threshold (e.g., 85%) sing-along detection engine 522 may not activate sing-along mode and continues to monitor voice input.

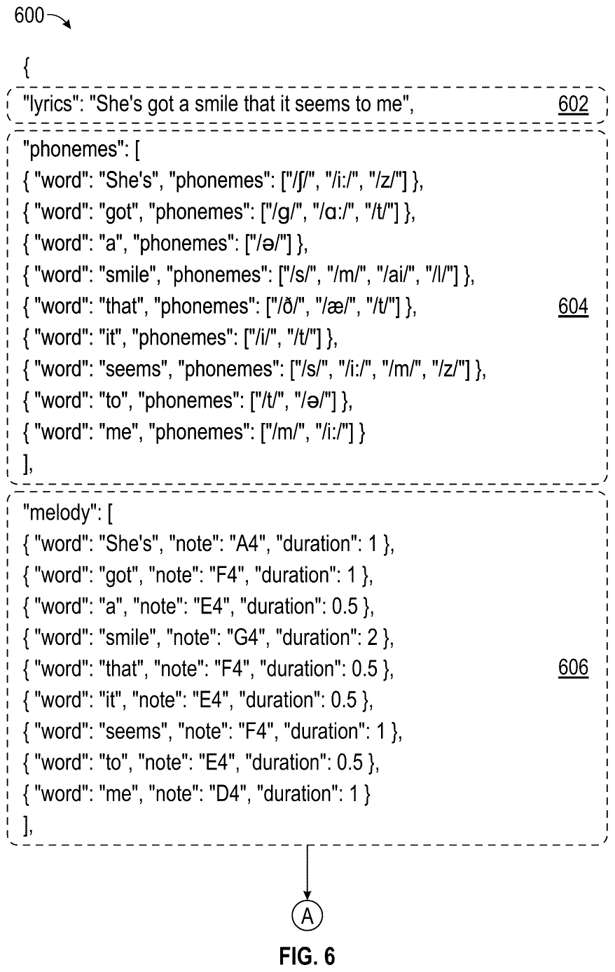

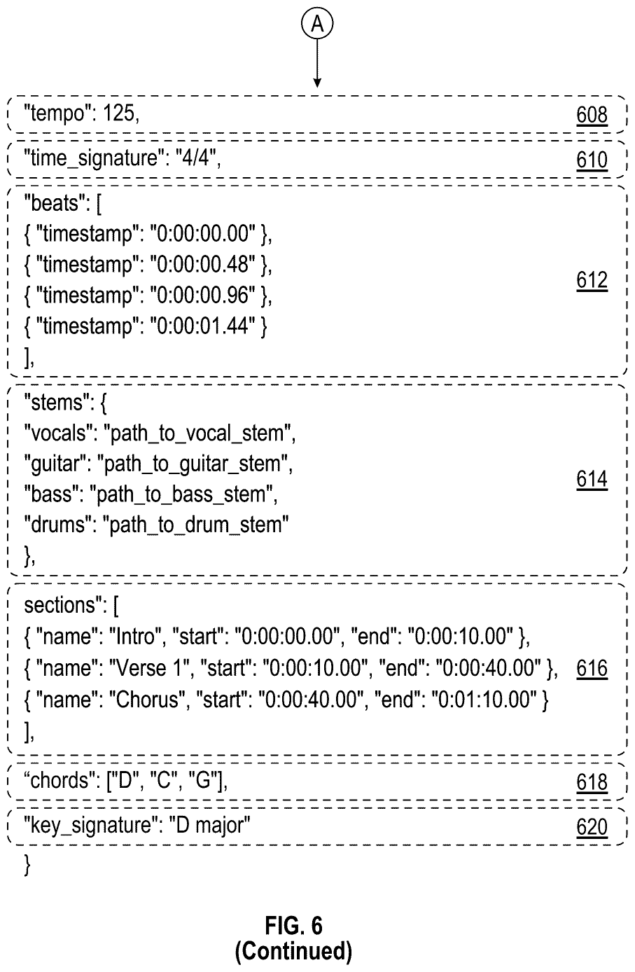

In some embodiments, for example, sing-along detection engine 522 may derive a phoneme match confidence score by comparing the detected phonemes of the voice input with the reference model created from the lyrics of the content item by the phoneme & melody analysis engine 521. For instance, sing-along detection engine 522 may determine that the similarity of the phonemes determined from the received voice input and the expected phoneme sequence from the metadata (e.g., metadata 600 of FIG. 6) of the content item being played, and, based on the similarity determined, the system may assign a similarity score based on the similarity determined.

In some embodiments, for example, sing-along detection engine 522 may derive and assign a melody alignment confidence score by comparing the detected pitch contour (e.g., change in pitch over time) of the voice input with the melody attributes (e.g., pitch, tempo, rhythm, etc.) of the content item determined by the phoneme & melody analysis engine 521. The sing-along detection engine 522 may, for example, utilize pitch detection algorithms and alignment methods (e.g., dynamic time warping) to account for timing variations.

In some embodiments, for example, sing-along detection engine 522 may derive and assign a tempo synchronization confidence score by using algorithms that track rhythmic patterns and onsets to determine a similarity between the vocal timing from the received voice input and the expected tempo and beat determined by the phoneme & melody analysis engine 521. Sing-along detection engine 522 may, for example, implement signal-to-noise ratio analysis to determine the clarity of the vocal input and apply digital signal processing (DSP) prior to determining confidence scores.

In some embodiments, sing-along detection engine 522 may score each of the factors (e.g., phoneme similarity, melody alignment, tempo synchronization, etc.) individually and may combine the scores to determine an overall confidence score. In some embodiments, sing-along detection engine 522 may be configurable to assign static contribution percentages to each factor to weight the contribution of each factor to the overall confidence score. For example, phoneme matching and melody alignment may each contribute 40% to the overall confidence score, while tempo synchronization contributes 20%. In some embodiments, sing-along detection engine 522 may dynamically adapt contribution percentages of each factor of the overall confidence score based on the progression of the song. For example, during instrumental breaks, sing-along detection engine 522 may prioritize melody alignment and tempo synchronization over phoneme matching. In another example, during vocal sections, sing-along detection engine 522 may prioritize phoneme matching as the dominant factor. In some embodiments, if the confidence score of any of the factors, e.g., phoneme similarity, melody alignment, tempo synchronization, or the like, exceeds a high threshold, for example, 85% or 75-95%, then the system may determine a match irrespective of the confidence scores of other factors.

In some embodiments, for example, in the absence of metadata, sing-along detection engine 522 may rely on general pitch and rhythm patterns derived from the audio signal to approximate alignment.

In some embodiments, sing-along detection engine 522 may comprise one or more ML models trained on various vocal datasets to detect singing accurately and improve detection over time through refinement or retraining of the ML models. For example, the one or more ML models can be utilized to predict pitch deviations, adapt phoneme matching thresholds, and refine melody alignment based on repeated user interactions.

Gesture detection engine 524 may comprise, for example, control circuitry (e.g., control circuitry 2004 of FIG. 20, control circuitry 2111 of FIG. 21, I/O circuitry 2002 of FIG. 20, I/O circuitry 2112 of FIG. 21, etc.) to determine a correlation indicator (e.g., confidence score) between signals from wearable sensors 516 and instrument stems of the content item being played to determine a corresponding instrument stem automatically. In some embodiments, the system may be configured (e.g., via a companion application) to provide a menu for user selection of an available stem of the content item to manipulate based on movements determined by the gesture detection engine 524.

In some embodiments, for example, when corresponding stems are available, the gesture detection engine 524 may detect movements corresponding to instrument stems (e.g., guitar, bass, drums, piano, harp, trumpet, trombone, saxophone, etc.), and/or conductor controls (e.g., comprising time signatures, tempo, cueing, volume, expression/mood, etc.). For example, wearable sensors 516 may comprise an IMU to determine features of the movement (e.g., linear acceleration, angular velocity, etc.). The gesture detection engine 524 may process these features (e.g., by using Kalman filters, ML models, or comparing to a data structure comprising movement signatures) to determine a confidence score between the user movements and the movements of the instrument stems or conductor controls of the content item being played and compare the confidence score to a predetermined confidence score threshold (e.g., 80% or a threshold between 51-99%) to determine whether the user is playing an air instrument or performing conductor movements of the content item.

In some embodiments, for example, if the confidence score meets or exceeds a predetermined threshold (e.g., 85%) the gesture detection engine 524 may determine that a user is performing a motion corresponding to a stem of the content item being played, activate manipulation of that corresponding stem based on determined movements, adjust the audio mix of the content item being played (e.g., spatially, audibly, etc.), and continue to process signals from wearable sensors 516 for the audio mix adjustment. In some embodiments, for example, if the confidence score is below a predetermined threshold (e.g., 85%) the gesture detection engine 524 continues to monitor signals from wearable sensors 516 to determine corresponding stem motions.

In some embodiments, for example, after gesture detection engine 524 determines a corresponding stem motion with 93% confidence (e.g., above the predetermined threshold), the gesture detection engine 524 activates manipulation of the corresponding stem, continues to process movements to determine movement features (e.g., speed, rhythm, direction, etc.), and manipulates the corresponding stem of the content item (e.g., volume, intensity, rhythm, tempo, etc.) based on the determined movements. For instance, upon determination of a violin gesture, subsequent signals determined by the gesture detection engine 524 may result in an increase of the intensity of the violin stem (e.g., in response to a fast bowing motion), a softer, more nuanced tones (e.g., in response to subtle movements), or an alteration of the spatialization of that string stem.

In some embodiments, for example, after gesture detection engine 524 determines a corresponding stem motion, gesture detection engine 524 may determine that the corresponding stem motion has stopped, another selection for a different stem has been made, and/or another corresponding stem motion has a confidence score above a predetermined confidence score threshold. Thus, output from gesture detection engine 524 may be used to dynamically transition between manipulation of the plurality of stems available for a content item. For instance, when gesture detection engine 524 determines that a guitar strumming gesture has stopped and a drumming motion has started, the system may restore the guitar stem and start, emphasize, or modify the drum stem based on the determined movements.

Spatial audio processing engine 526 may comprise, for example, control circuitry (e.g., control circuitry 2004 of FIG. 20, control circuitry 2111 of FIG. 21, I/O circuitry 2002 of FIG. 20, I/O circuitry 2112 of FIG. 21, etc.) to manipulate the spatial audio arrangement of the content item audio stems (e.g., spatial audio layout 200 of FIG. 2, spatial audio layout 400 of FIG. 4). For example, a content item may have metadata corresponding to the spatial location within an audio landscape in which each audio stem is originally located (e.g., in FIG. 2, keyboard stem 104 is located to the right in the audio landscape). In some embodiments, a companion application of user equipment 518 may prepopulate an audio spatialization layout displayed on the user interface of user equipment 518 based on the original location metadata or genre-based location metadata. In some embodiments, a companion application of user equipment 518 may be used to create a custom spatial layout for an audio landscape showing where each audio stem is located (e.g., via user interface 800 of FIG. 8).

In some embodiments, spatial audio processing engine 526 may manipulate the spatial audio arrangement of the content item audio stems based on determinations from sing-along detection engine 522 and/or gesture detection engine 524. For example, in FIG. 2, upon determination that a voice input 112 corresponds to vocal stem 110 of FIG. 1, spatial audio processing engine 526 may arrange (e.g., center) the audio based on the user voice data 112′ and arrange audio stems (e.g., drum stem 102, keyboard stem 104, guitar stem 106, and bass stem 108) around the audio based on the user voice data 112′. For example, in FIG. 4, upon determination that a movement or gesture corresponds to guitar stem 106, spatial audio processing engine 526 may arrange (e.g., center) the corresponding guitar stem 106′ and arrange audio stems (drum stem 102, keyboard stem 104, and bass stem 108) around the corresponding stem. In another example, wearable sensors 516 and/or user equipment 518 may determine user movement, and spatial audio processing engine 526 may move the other stems of the content item relative to the determined user movement to simulate moving through the audio landscape.

In some embodiments, gesture detection engine 524 provides spatial audio processing engine 526 with determined conductor movements to dynamically adjust the spatial audio arrangement based on the conductor movements. For example, the system may control the spatial audio mix of a content item comprising a plurality of orchestral stems by receiving simulated conducting gestures. For example, wearable sensors 516 and/or user equipment 518 may be used to track head movements (e.g., tilting, nodding, head gaze, etc.) of the user and cause spatial audio processing engine 526 to adjust the overall volume or to emphasize specific sections of the orchestra corresponding to the movement. For example, upon determination that a head movement corresponds to the head turning toward the audio of the brass section, the spatial audio processing engine 526 increases the prominence of the brass stem in the spatial audio mix. By way of illustrative example, the system may determine that in the spatial audio soundscape provided by the stereo system in relation to a physical position detected for the user, the user currently perceives the brass section as coming from the left speaker. Therefore, if the system detects that the user's head is turning left, or is raising the left arm, the system may interpret this as the user indicating the brass section. In another example, the determined head movement may select the audio stem of the direction of the head movement, and the spatial audio processing engine 526 adjusts the audio of the selected stem based on additional gestures (e.g., hand movement, wrist movement, arm movement, etc.). For instance, wearable sensors 516 and/or user equipment 518 may be used to track wrist movements and adjust the intensity, tempo, or volume of the stem selected based on the wrist movements (e.g., a quick upward flick of the wrist could trigger a crescendo, a downward motion slows the tempo, etc.). In another example, spatial audio processing engine 526 may enhance the clarity, volume, and/or prominence of an audio stem when wearable sensors 516 and/or user equipment 518 determine that the user is moving toward the audio stem.

Special effects engine 528 may comprise, for example, control circuitry (e.g., control circuitry 2004 of FIG. 20, control circuitry 2111 of FIG. 21, I/O circuitry 2002 of FIG. 20, I/O circuitry 2112 of FIG. 21, etc.) to apply audio effects (e.g., reverb, echo, pitch correction, equalization, harmonization, etc.) to a received voice input (e.g., from microphone 512). In some embodiments, special effects engine 528 may generate effects based on the voice input and may output only the generated effects (e.g., without output of the received voice input). For example, special effects engine 528 may alter or replace a voice input that has been determined to be singing along to the content item by sing-along detection engine 522 and provide the output of the processed or generated stem to sing-along/band mode synchronization engine 542 for combination with the other stems of the content item. By way of illustrative example, the system may receive and process (e.g., filter) voice input 112 of FIG. 1, determine voice input 112 corresponds to vocal stem 110, and apply one or more effects (e.g., reverb) to voice input 112 to generate and output audio based on the user voice data 112′. In another example, the system may generate audio based on the user voice data by extracting features of the voice input (e.g., phoneme, melody, pitch, etc.) and using a generative model to use the extracted features to generate audio output to sound like a particular persona (e.g., lead singer such as Paul McCartney, character such as Bugs Bunny, etc.).

In some embodiments, special effects engine 528 comprises a digital signal processor to perform real-time signal processing for applying or generating the desired vocal effects. For example, the digital signal processor may perform voice isolation, noise suppression, and/or dynamic audio adjustments. In some embodiments, special effects engine 528 further comprises advanced signal processing algorithms to implement the vocal effects. For example, the special effects engine 528 may generate reverb and echo using convolution or algorithmic methods to simulate acoustic environments, correct pitch by adjusting the voice input pitch to match the key of a song (e.g., via vocoding, time-domain pitch shifting, etc.), and/or tailor frequency response to generate equalization and harmonization to add additional layers of sound that blend naturally with the voice input. Special effects engine 528 provides output of the processed or generated stem to sing-along/band mode synchronization engine 542 for combination with the other stems of the content item.

In some embodiments, special effects engine 528 may be configured using the companion application of user equipment 518. For example, the companion application may provide user-selectable options for specific effects (e.g., reverb, echo, pitch correction, equalization, harmonization, etc.), adjustment parameters (e.g., intensity, tempo, compression, pitch shift, distortion, etc.), and/or predefined sound profiles (e.g., concert hall, studio, pop vocalist, etc.). For example, predefined sound profiles may be implemented as parameter sets in the digital signal processor that define audio characteristics (e.g., reverb decay time, pitch correction thresholds, equalization curves, etc.). In some embodiments, the companion application may provide user customization of settings to generate sound profiles. In some embodiments, the companion application may be controlled via touch controls, gesture controls, and/or voice commands directly integrated with user equipment or via Bluetooth or other wireless protocol of a companion device.

In some embodiments, cloud services module 530 may comprise, e.g., streaming platform application programming interface (API) 532, metadata storage 534, cloud processing 536, and real-time collaboration server 538. Streaming platform API 532 may comprise, for example, one or more APIs to deliver content, manage user interactions, and/or optimize performance. Streaming platform API 532 enables integration of system local and remote processes. For example, streaming platform API 532 may be utilized to transfer processing to remote servers when local device latency is greater than a predetermined threshold. Metadata storage 534 may comprise, for example, remote storage (e.g., storage circuitry 2114 of FIG. 21, storage circuitry 2122 of FIG. 21, etc.) for metadata of content items (e.g., metadata 600 of FIG. 6). For example, metadata may be from content items with a plurality of audio stems (e.g., pre-processed, by stem extraction engine 552, etc.). For example, metadata may be user information (profile, preferences, configurations, history, etc.). Profile preferences may specify that the user prefers that the lead vocal of the prerecorded audio performance be muted totally, or alternatively, that it be lowered in volume but not muted, when the system detects user audio matching the lead vocal of the prerecorded audio performance. Profile preferences may specify that the user prefers that the lead vocal of the prerecorded audio performance be spatial audio centered, or that some instrumental stems be made more prominent together with the user's audio input. By way of further example, profile preferences may indicate that the user tends to sing-along with some songs, some artists, some genres of music, some eras or decades of music, or the like. Accordingly, when the system detects user audio during the play of prerecorded audio performances of such songs, artists, genres of music, eras or decades of music, or the like, a lower confidence score for commencing sing-along mode may be sufficient to activate sing-along mode. Cloud processing 536 may comprise, for example, one or more remote servers (e.g., server 2104 of FIG. 21, edge computing device 2116 of FIG. 21, etc.) available to the system for processing computational tasks. For example, the system may offload (e.g., for latency handling) computational tasks including storing audio content, stemming audio content, delivering audio content, adjusting stems of audio content, determining that singing input matches a playing content item, determining that gesture input matches a playing content item, merging or recording remote sessions of more than one user, and/or running the companion application, or any other processing or combination thereof to cloud processing. Real-time collaboration server 538 may comprise, for example, low-latency communication protocols (e.g., WebRTC, QUIC, etc.) to synchronize live voice input and instrument controls across participants. For example, real-time collaboration server 538 may integrate each participant contribution (e.g., voice input, instrument gesture, etc.) into a spatial audio mix that positions the stems from the original audio and/or participant contributions into one audio landscape. In some embodiments, for example, during higher latency, real-time collaboration server 538 may record each participant contribution, synchronize the audio stems into a spatial audio mix and store them in the cloud for editing, playback, or sharing after the session. In some embodiments, for any system mode, real-time collaboration server 538 may capture and store each participant contribution in the cloud separately for editing, playback, or sharing after the session.

In some embodiments, playback & interaction module 540 may comprise, e.g., sing-along/band mode synchronization engine 542, head-tracking engine 544, earbud control 546, and spatial audio output 548.

Sing-along/band mode synchronization engine 542 may comprise, for example, control circuitry (e.g., control circuitry 2004 of FIG. 20, control circuitry 2111 of FIG. 21, I/O circuitry 2002 of FIG. 20, I/O circuitry 2112 of FIG. 21, etc.) to align (e.g., synchronize) the stems generated and/or provided by spatial audio processing engine 526, special effects engine 528, and real-time collaboration server 538 so that playback of spatial audio output 548 comprising stems of the original content item, modified stems, and/or additional stems is substantially aligned with the original audio of the content item. In some embodiments, alignment includes both temporal and spatial alignment of the stems. For example, sing-along/band mode synchronization engine 542 may synchronize stems by aligning time references (e.g., tempo), using time-stretching to correct timing misalignments, aligning waveform phases, aligning transients using waveform analysis, and/or using AI-powered tools (e.g., Izotope RX Music Rebalance, LANDR, etc.). In another example, a sing-along/band mode synchronization engine 542 may synchronize stems by using time-stamped packets and buffer management to align vocal input with the other content item audio stems.

Head-tracking engine 544 may comprise, for example, control circuitry (e.g., control circuitry 2004 of FIG. 20, control circuitry 2111 of FIG. 21, I/O circuitry 2002 of FIG. 20, I/O circuitry 2112 of FIG. 21, etc.) to determine input controls for playback control 556. In some embodiments, head-tracking engine 544 receives data from wearable sensors 516 and/or user equipment 518. For example, from the sensor data, head-tracking engine 544 may determine head movements (e.g., tilting, nodding, head gaze, etc.) corresponding to playback controls (e.g., volume, play, pause, fast-forward, rewind, skip, save session, move through audio landscape, etc.). In some embodiments, playback controls may include stem-specific controls (e.g., volume, pitch, special effects, etc.). In some embodiments, head-tracking engine 544 may determine user movement within the audio landscape and provide output to playback control 556 corresponding to stem adjustments relative to the determined movement for update to spatial audio output 548. In some embodiments, input controls and corresponding gestures may be predefined and/or configurable in the companion application.

Earbud control 546 may comprise, for example, control circuitry (e.g., control circuitry 2004 of FIG. 20, control circuitry 2111 of FIG. 21, I/O circuitry 2002 of FIG. 20, I/O circuitry 2112 of FIG. 21, etc.) to adjust the audio mix dynamically through received interactions with earbuds (e.g., headphones 514) associated with user equipment 518 (e.g., as illustrated in FIG. 11). For example, earbud control 546 may determine controls based on interaction with a physical button on the side of the earbud, pressure sensing, capacitive or impedance-based touch sensing, motion sensing (e.g., head gestures), proximity sensing (e.g., using infrared light), or voice sensing. Earbud control 546 may determine changes in pressure (e.g., when the earbud is pressed farther into the ear canal) by receiving measurements of deformation or force changes on the surface of the earbud from small strain or force sensors. Earbud control 546 may determine contact to the earbud housing by receiving capacitance or impedance measurements of one or more electrodes (e.g., an increase in capacitance corresponds to touch, a decrease in impedance corresponds to touch, etc.). In some embodiments, earbud control 546 may adjust the audio mix (e.g., increase volume of a stem) based on a button press, modify backing track volume or vocal clarity based on a detected pressure, or adjust spatial audio settings based on a detected touch.

For example, upon detecting a pressure input, earbud control 546 may increase the gain of the voice input received by headphones 514 relative to the backing tracks. In some embodiments, earbud control 546 may lower instrumental tracks and/or apply effects (e.g., equalization, reverb, etc.). In some embodiments, earbud input controls and corresponding earbud interactions may be predefined and/or configurable in the companion application.

Spatial audio output 548 may comprise, for example, spatial audio that comprises original stems of the content item (e.g., generated by stem extraction engine 552), voice input stems (e.g., received by microphone 512), and/or modified stems (e.g., by spatial audio processing engine 526 or special effects engine 528) that are synchronized (e.g., by sing-along/band mode synchronization engine 542 or audio synchronization engine 554) and played, with or without additional spatial audio modifications (e.g., by playback control 556).

In some embodiments, music data processing module 550 may comprise, e.g., stem extraction engine 552 (e.g., MDX-Net, Demucs, Logic Pro, etc.), audio synchronization engine 554, and playback control 556.

Stem extraction engine 552 may comprise, for example, ML models (e.g., MDX-Net, Demucs, etc.) or applications (e.g., Logic Pro,) to perform audio stemming of a content item to generate individual stems from the single audio track to represent distinct elements (e.g., vocals, strings, percussion, and other instruments). For example, stem extraction engine 552 may extract stems from original content item 801 to generate content item 100 with stems, as illustrated in FIG. 8. In some embodiments, stem extraction engine 552 may generate metadata (e.g., metadata 600 of FIG. 6) for each generated stem that may be utilized by sing-along detection engine 522 for voice determination, gesture detection engine 524 for movement determination, spatial audio processing engine 526 for spatial arrangement of the generated stems, and/or audio synchronization engine 554 for playback alignment of the generated stems. For example, stem extraction engine 552 may determine features in the audio stems (e.g., lyrics, tempo, rhythm, transitions, changes in volume level, changes in prominence of a stem, changes in spatial location of a stem, etc.). In some embodiments, stem extraction engine 552 may comprise, for example, a natural language processing (NLP) artificial intelligence (AI) to convert lyrics of a content item into phonemes and/or phoneme sequences, thus creating a reference model for comparison with a vocal input. In some embodiments, such conversion may be performed in real time in response to user audio input being detected when the prerecorded audio performance is being played. In some embodiments, stem extraction engine 552 may analyze melody data to extract pitch information for vocal or instrumental stems that may be used to compare the melody data with a voice input. In some embodiments, stem extraction engine 552 may analyze tempo and beat information of a content item (e.g., beats per minute, time signature, etc.) to establish a rhythmic framework for analyzing against corresponding rhythmic information from a voice input. In some embodiments, stem extraction engine 552 may analyze and/or generate segmentation metadata corresponding to verses, choruses, and instrumental breaks describing the structure of a content item for analyzing against corresponding information from a voice input. In some embodiments, such analysis and processing may be performed in real time in response to user audio input being detected when the prerecorded audio performance is being played. In some embodiments, stem extraction engine 552 may determine residual audio data that could not be extracted into a classified audio stem and generate a miscellaneous audio stem. For example, stem extraction engine 552 may analyze this miscellaneous audio stem to provide frequency-based spatialization metadata that may be used to enhance the spatial sound effect of surrounding the user with instruments. In some embodiments, the system may maintain a dictionary and/or database of phonemes, phoneme sequences, lyrics, melody and/or metadata (e.g., metadata 600 of FIG. 6) stored in a data structure in system memory (e.g., metadata storage 534, in storage circuitry 2008 of FIG. 20, storage circuitry 2114 of FIG. 21, or any other suitable storage) for comparison with the vocal input of the user.

Audio synchronization engine 554 may comprise, for example, control circuitry (e.g., control circuitry 2004 of FIG. 20, control circuitry 2111 of FIG. 21, I/O circuitry 2002 of FIG. 20, I/O circuitry 2112 of FIG. 21, etc.) to align (e.g., synchronize) the stems generated by stem extraction engine 552 so that playback of spatial audio output 548 comprising stems of the original content item is substantially similar to the original audio of the content item. In some embodiments, alignment includes both temporal and spatial alignment of the stems. For example, audio synchronization engine 554 may synchronize stems by aligning time references (e.g., tempo), using time-stretching to correct timing misalignments, aligning waveform phases, aligning transients using waveform analysis, and/or using AI-powered tools (e.g., Izotope RX Music Rebalance, LANDR, etc.).

Playback control 556 may comprise, for example, control circuitry (e.g., control circuitry 2004 of FIG. 20, control circuitry 2111 of FIG. 21, I/O circuitry 2002 of FIG. 20, I/O circuitry 2112 of FIG. 21, etc.) to process inputs from sing-along/band mode synchronization engine 542, earbud control 546, head-tracking engine 544, and audio synchronization engine 554 and generate spatial audio output 548 for output by headphones 514.

In some embodiments, system components of system architecture 500 may be implemented by a single entity (e.g., equipment manufacturer) with compatible devices that have music streaming capabilities. In some embodiments, system components of system architecture 500 may be implemented by music streaming services though APIs with compatible devices.

FIG. 6 illustrates an example of metadata 600 of a prerecorded audio performance, according to an example of an aspect of some embodiments of the present disclosure. In this example, metadata 600 is in JSON format. In some embodiments, metadata 600 may be stored (e.g., in storage circuitry 2008 of FIG. 20, storage circuitry 2114 of FIG. 21, storage circuitry 2122 of FIG. 21, etc.) as extensible markup language (XML), YAML, Tom's obvious, minimal language (TOML), initialization file (INI), resource description framework (RDF), comma-separated values (CSV), binary formats (e.g., Parquet, Avro, etc.), database format (e.g., SQL database, NoSQL database, etc.), library metadata formats (e.g., Dublin Core (DC), machine-readable cataloging (MARC), etc.), extensible metadata platform (XMP), or any other suitable metadata format or combination thereof. This metadata may be encoded in a standardized format to ensure compatibility with the system.

In some embodiments, metadata 600 may include lyrics metadata 602, phoneme metadata 604, melody metadata 606, tempo metadata 608, time signature metadata 610, beat metadata 612, stem metadata 614, section metadata 616, chord metadata 618, and key signature metadata 620. For example, the system may generate or receive metadata 600 for the song “Sweet Child O' Mine” by Guns N' Roses, which may include detailed information that the system may utilize for singing detection and alignment with the song. To illustrate, the system may map the lyrics (e.g., words) of the opening line, “She's got a smile that it seems to me,” to corresponding phonemes to create a timeline of expected phoneme patterns, as shown in phoneme metadata 604. For example, the system correlates the word “She's” to phonemes “/∫/” “/i:/”, “/z/”, and correlates the word “smile” to phonemes “/s/”, “/m/”, “/ai/”, “/l/”. Melody metadata 606 may include pitch information (e.g., notes and duration) for each word of the lyrics. To illustrate, the system may determine that the word “She's” corresponds to a given key (e.g., A4, B3, G1, etc.) that is sustained for a duration (e.g., one beat, half a beat, etc.) and “smile” corresponds to another key sustained for two beats. The system may determine speed (e.g., tempo metadata 608), structure (e.g., time signature metadata 610), and timestamp corresponding to features (e.g., beat metadata 612, chorus, bridge, section metadata 616, stem metadata 614, etc.) of the song. For example, the system may determine “Sweet Child O' Mine” has a tempo of 125 beats per minute (BPM), a 4/4 time signature, and store specific timestamps marking each beat. The system may determine harmonic metadata (e.g., chord metadata 618, key signature metadata 620, etc.) specifying the chord progression (e.g., D major to C major to G major) and the key of the song (e.g., D major). In some embodiments, the system may implement dynamic segmentation to define sections (e.g., intro, verses, choruses, bridge, outro, stems, etc.), thus the system may comprise an adaptable detection process based on the structure of the song. For example, stems include isolated tracks for vocals (e.g., lead, chorus, etc.), guitars, bass, drums, and any other instrument or combination thereof. The system may then access the dynamic segmentation metadata (e.g., stems, sections, features, timings etc.) to cause modification (e.g., suppressing the lead vocal stem volume during sing-along mode, adjusting spatial arrangement of audio stems, and increasing prominence of an instrument stem during receipt of user gesture data, etc.) of the play of the audio.

FIG. 7 is a sequence diagram 700 for sing-along mode, according to an example of an aspect of some embodiments of the present disclosure. In various embodiments, the individual steps of sequence diagram 700 may be implemented by one or more components of the devices, systems, and/or methods of FIGS. 1-21 and may be performed in combination with any of the other processes and aspects described herein. Although the present disclosure may describe certain steps of sequence diagram 700 (and of other processes described herein) as being implemented by certain components of the devices, systems, and/or methods of FIGS. 1-21, this is for purposes of illustration only. It should be understood that, e.g., other components of the devices, systems and methods of FIGS. 1-21 may implement those steps instead.

In some embodiments, at 702, playback device 709 receives a request from the user to play a content item (e.g., song, music, recording, track, audio, synthetic audio, etc.) and, at 703, provides regular playback of the content item. In some embodiments, playback device 709 may comprise, for example, user equipment 518 of FIG. 5. In some embodiments, the request is received through a user interface (e.g., physical button, voice recognition, touch selection, gesture recognition, etc.) of the playback device 709. In some embodiments, the requested content item comprises a plurality of audio stems. In some embodiments, the requested content item does not comprise a plurality of audio stems. For example, the system may process the content item (e.g., via stem extraction engine 552 of FIG. 5) to generate a plurality of audio stems and may generate corresponding metadata based on the content item and/or based on a search of outside sources that store lyrics, sheet music, musical or other audio information, or the like. In some embodiments, regular playback comprises outputting an original (e.g., unstemmed or pre-stemmed) content item. In some embodiments, regular playback comprises outputting a reconstructed (e.g., stemmed) content item. In some embodiments, regular playback comprises an original or a reconstructed content item played with special effects and/or with playback controls. In some embodiments, playback device 709 and system 705 continuously monitor audio playback of content items (e.g., rather than receiving a specific content item request) to determine when a supported content item is being played. For example, a supported content item may include content items with associated metadata (e.g., lyrics or melody information), available through streaming services or local playback. Upon determining a supported content item, system 705 proceeds to 710.

In some embodiments, at 704, playback device 709 sends a request for metadata (e.g., metadata 600 of FIG. 6) to metadata service 707. For example, metadata may include lyrics, phonemes, melody, tempo, time signature, beat, stems, sections, chords, key signature, spatial layout and any other aspect of a content item, or combination thereof. In some embodiments, playback device 709 may locally store metadata (e.g., in storage circuitry 2008 of FIG. 20) received from metadata service 707. For example, playback device 709 may store content item metadata for future play requests to reduce latency of requesting and receiving metadata.

In some embodiments, at 706, metadata service 707 returns the requested metadata to playback device 709.

In some embodiments, at 708, for example, when playback device 709 determines the content item requested in 702 comprises metadata (e.g., comprising multiple audio stems), playback device 709 provides system 705 with the metadata of the content item being played.

Based on the metadata, system 705 may activate voice capture of microphone 703 at 710.

In some embodiments, at 712, microphone 703 receives voice input from the user. In some embodiments, microphone 703 may employ noise-filtering techniques (e.g., adaptive noise cancellation, signal normalization, spectral subtraction, echo cancellation, beamforming, high-pass filter, low-pass filter, etc.) to refine the voice input for analysis. For example, the noise-filtering techniques may be tailored to a determined environment to isolate the voice of the user from environmental sounds. For example, in a vehicle, (e.g., an automobile traveling on a road) adaptive noise cancellation may be employed to reduce road noise. In another example, in quieter settings, simple pass filtering methods may be employed to enhance the clarity of the vocal input. In some embodiments, at 714, microphone 703 transmits the filtered audio stream to system 705.

In some embodiments, at 716, system 705 may (e.g., through phoneme & melody analysis engine 521 of FIG. 5) analyze the vocal input. For example, system 705 may comprise a natural language processing (NLP) artificial intelligence (AI) and/or other ML model trained on various vocal datasets to perform real-time audio analysis of the voice input for comparison with stored or retrieved metadata. For example, system 705 may determine pitch, rhythm, tempo, beats per minute, and/or time signature of the voice input to compare against metadata of the playing content item. In some embodiments, system 705 may analyze the voice input for alignment with segmentation metadata describing verses, choruses, and instrumental breaks of the playing content item. In some embodiments, system 705 may maintain a dictionary and/or database of analyzed voice inputs, outputs, and outcomes stored in a data structure in system memory (e.g., metadata storage 534, in storage circuitry 2008 of FIG. 20, storage circuitry 2114 of FIG. 21, or any other suitable storage) for refinement or retraining of the ML model.

In some embodiments, at 718 and 720, system 705 may transmit the determined phonemes, melody, tempo, and/or other data determined from the analysis of the voice input to metadata service 707 to compare against metadata of the playing content item. For example, metadata service 707 may compare the determined phonemes of the voice input to phonemes of the metadata and determine a phoneme similarity score. For example, metadata service 707 may compare the determined melody of the voice input to the melody of the metadata and determine a melody alignment score and/or may compare the determined tempo of the voice input to the tempo of the metadata and determine a tempo synchronization score. In some embodiments, at 722, metadata service 707 may return results of the comparison (e.g., one or more comparison scores) between the analysis of the voice input and the metadata to system 705.

In some embodiments, at 724, system 705 may (e.g., through sing-along detection engine 522 of FIG. 5) calculate a confidence score corresponding to the similarity between the voice input and the content item being played and compare the confidence score to a predetermined confidence score threshold (e.g., 80%) to determine whether the user is singing the lyrics of the content item. In some embodiments, system 705 integrates multiple factors (e.g., phoneme similarity, melody alignment, tempo synchronization, etc.) to calculate a confidence score.

In some embodiments, for example, if the confidence score meets or exceeds (e.g., is greater than or equal to) a predetermined threshold (e.g., 85%), system 705 proceeds to 726-730. In some embodiments, for example, if the confidence score is below (e.g., is less than) a predetermined threshold (e.g., 85%), system 705 proceeds to 732.

In some embodiments, at 726 and 728, system 705 has determined that the confidence score meets or exceeds a predetermined threshold and may suppress (e.g., mute, reduce volume, etc.) a vocal stem (e.g., lead vocals, chorus vocals, etc.), integrate the voice input with the other stems of the content item (e.g., through sing-along/band mode synchronization engine 542 of FIG. 5), and/or spatially arrange (e.g., through spatial audio processing engine 526 of FIG. 5) one or more instrument stems (e.g., as illustrated in FIG. 2). In some embodiments, 726 and 728 may occur in sequence or may occur substantially simultaneously.

In some embodiments, at 730, system 705 activates sing-along mode of playback device 709. For example, in sing-along mode, system 705 provides playback device 709 with the modified content item comprising the voice input (e.g., as illustrated in FIG. 1B) for output. In some embodiments, sing-along mode comprises continuous monitoring of voice and gesture inputs to modify the content item accordingly. For example, system 705 may determine that the location of the voice input has movement and, based on the movement, adjusts the spatial arrangement of the stems according to the current position of the user.

In some embodiments, at 731, playback device 709 outputs the modified content item. For example, playback device 709 may output the modified audio through headset 207 of FIG. 2, headphones 514 of FIG. 5, audio output equipment 2014 of FIG. 20, or any suitable audio output device or combination thereof.

In some embodiments, at 732, system 705 has determined that the confidence score is below a predetermined threshold, and playback device 709 continues to output regular playback. In some embodiments, regular playback comprises outputting an original (e.g., unstemmed or stemmed) content item. In some embodiments, regular playback comprises an original or a reconstructed content item played with special effects and/or with playback controls.

In some embodiments, at 734, system 705 continues to monitor the user voice input, for example, through microphone 703. For example, system 705 may determine the audio input corresponding to the vocal stem has stopped, audio input corresponding to the vocal stem has started, another selection for a different stem has been made, and/or another corresponding vocal stem has a confidence score above a predetermined confidence score threshold. Thus, system 705 may dynamically transition between manipulation of a plurality of vocal stems available for a content item. For instance, when system 705 determines that a voice input corresponding to lead vocals has stopped and a voice input for secondary vocals has started, the system 705 may restore the lead vocal stem and attenuate or mute the secondary vocal stem based on the determined voice input.

FIG. 8 illustrates an example of a user interface 800 to customize the spatial audio layout of prerecorded audio stems, according to an example of an aspect of some embodiments of the present disclosure.

In some embodiments, the system may extract stems (e.g., via stem extraction engine 552) from an original content item 801 that is without stems. In this way, content item 100 with stems (e.g., drum stem 102, keyboard stem 104, guitar stem 106, bass stem 108, and vocal stem 110) may be generated. In some embodiments, content items may originally contain stems or may be pre-processed externally to generate stems.

In some embodiments, user equipment 518 comprises a GUI to display the companion application. In this GUI, the companion application may provide an interface for customizing the spatial arrangement of content item audio stems in audio landscape 820. For example, the companion application may allow selection of preconfigured spatial arrangements of content item audio stems, such as the original determined stem location of the content item, a genre-based stem location (e.g., pop, rock, etc.), or a stored custom configuration. Such preconfigured spatial arrangements may be associated with a user profile and accessed from another device, accessed online, or shared with a second user for use by the second user for a sing-along session or for one or more of the other implementations discussed herein. In some embodiments, the companion application may provide an interface for custom arrangement of each audio stem. For instance, on the right-hand side of the GUI, the companion application may generate for display a vertical scrolling list of content item stems, and on the left-hand side of the GUI, the companion application may generate for display the audio landscape 820 with positioned stems (e.g., keyboard stem 104, bass stem 108 and vocal stem 110). The companion application may receive a user interaction with the GUI for modifying a spatial layout; for example, the user interaction may comprise pressing a physical button, voice recognition, touch selection, gesture recognition, or any other suitable interaction for modifying a spatial layout. For instance, user interaction 830 comprises a drag and drop touchscreen control to place keyboard stem 104 at a location of audio landscape 820.

In some embodiments, for example, where the system determines compatibility (e.g., matching melody metadata) between content items, the system may allow the selection of stems from more than one content item to merge into one modified content item and/or one spatial arrangement. In some embodiments, the companion application may generate for display the name of the one or more content items being arranged on the GUI (e.g., at the bottom). In some embodiments, not all audio stems are required to be placed in audio landscape 820, thus allowing selection and spatial arrangement of only a sampling of the available audio stems. For example, when only keyboard stem 104, bass stem 108, and vocal stem 110 have been arranged in audio landscape 820, as illustrated, the system may align, manipulate and output only those that have been arranged. In some embodiments, the companion application may provide an interface for applying spatial paths for selected instrument stems. For example, the companion application may receive a spatial path for the bass guitar stem to move from the left side of audio landscape 820 to the right side of audio landscape 820. Thus, the companion application may be used to generate a spatial choreography for the spatial arrangement of audio stems.

In some embodiments, audio landscape 820 may be configured to be static or dynamic once the stems have been arranged. For example, when audio landscape 820 is configured to be static, the spatial arrangement is locked into position and remains unchanged if the system determines user movement or gestures. In another example, when audio landscape 820 is configured to be dynamic, system determination of user movement and/or gestures may be used to update audio landscape 820 accordingly. In some embodiments, the companion application may show the audio landscape 820 dynamically adapting via the GUI. For example, when the system determines that a user has moved relative to the positioning of an instrument stem, the companion application will show a user indicator moving relative to the graphic of the instrument stem in audio landscape 820 displayed on the GUI.

FIG. 9 is a sequence diagram 900 for spatialization of audio stems, according to an example of an aspect of some embodiments of the present disclosure. In various embodiments, steps of processes 700 and 900 are corresponding. For example, step 702 of FIG. 7 may generally correspond with step 902 of FIG. 9. Accordingly, upon identical or substantially similar steps, correspondence is indicated (details of identical or substantially similar steps are omitted for brevity). In various embodiments, the individual steps of sequence diagram 900 may be implemented by one or more components of the devices, systems, and/or methods of FIGS. 1-21 and may be performed in combination with any of the other processes and aspects described herein. Although the present disclosure may describe certain steps of sequence diagram 900 (and of other processes described herein) as being implemented by certain components of the devices, systems, and/or methods of FIGS. 1-21, this is for purposes of illustration only. It should be understood that, e.g., other components of the devices, systems and methods of FIGS. 1-21 may implement those steps instead.

Steps 902-914 generally correspond to steps 702-714 of FIG. 7, respectively.

Step 916 generally corresponds to steps 716-724 of FIG. 7.

In some embodiments, at 918, system 905 has activated sing-along mode and may suppress or reduce the lead vocal stem of the content item. In some embodiments, at 920, system 905 may isolate stems of the content item (e.g., vocal stem, drum stem, guitar stem, etc.) and, at 922, system 905 may determine available spatial locations. For example, system 905 may use metadata to determine original spatial positions of the stems, system 905 may use genre-based positioning to determine locations for the stems, or system 905 may use custom configured locations for the stems (e.g., through user interface 800 of FIG. 8). In some embodiments, at 924, system 905 positions audio based on the user voice data (e.g., 112′ of FIG. 2) at the center of the audio space as the lead singer. In some embodiments, at 926, system 905 distributes instrument stems to spatial positions determined at 922. For example, distribution of the instrument stems may correspond to modifying the audio output of each instrument stem accordingly so that the stem perceivably sounds like it is spatially located in a respective location. For example, as illustrated in FIG. 2, guitar stem 106 in this instance may be located spatially behind and to the left of the user, drum stem 102 may be located spatially behind the user, bass stem 108 may be spatially located behind and to the right of the user, keyboard stem 104 may be located to the right of the user, and audio based on the user voice data 112′ may be located central to the user. For example, the spatial audio layout 200 of FIG. 2 may allow the user to perceive themself to be in the front and center of a band. Thus, system 905 creates an immersive audio experience, making the user feel as though they are performing with a live band.

In some embodiments, the system may have the ability to turn off the vocal stems of content items (e.g., when the vocal stem is isolated). In some embodiments, the system may employ signal processing techniques to suppress or reduce the vocal stem (e.g., lead vocals) of the content item. For example, the system may ensure that the user's voice (e.g., naturally or output audio based on the user voice data) is the primary focus of the audio output by isolating the vocal frequencies within the audio track and applying real-time attenuation of other frequencies of the track. In some embodiments, for example, if complete vocal stem removal is not possible (e.g., due to the limitations of the source audio), the system may minimize the vocal presence by filtering the stem or blending the stem into the background.

Steps 931-932 generally correspond to steps 731-732 of FIG. 7.

In some embodiments, system 905 comprises a companion application that includes a GUI for a user to select and/or arrange the audio spatial layout of the stems of a content item (e.g., as illustrated in FIG. 8). In some embodiments, at 934, system 905 may receive a user interaction (e.g., user interaction 830 of FIG. 8) with the GUI. For example, the user interaction may comprise pressing a physical button, voice recognition, touch selection, gesture recognition, or any other suitable interaction for modifying a spatial layout.

In some embodiments, at 936, system 905 adjusts (e.g., via spatial audio processing engine 526) the audio layout dynamically as system 905 receives layout adjustment from the companion application, as system 905 determines that the user is moving throughout the audio landscape, and/or as system 905 receives gesture inputs corresponding to playback controls of the audio stems.

In some embodiments, the companion application may store (e.g., in storage circuitry 2008 of FIG. 20, storage circuitry 2114 of FIG. 21, storage circuitry 2122 of FIG. 21, or any other suitable storage) any new or modified spatial arrangements created for subsequent use or modification.

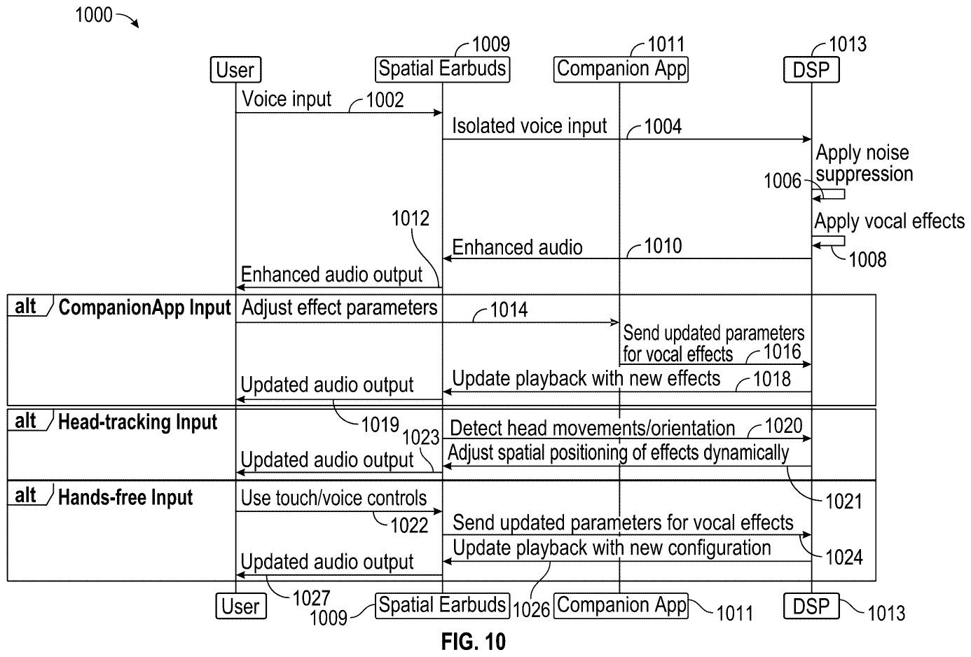

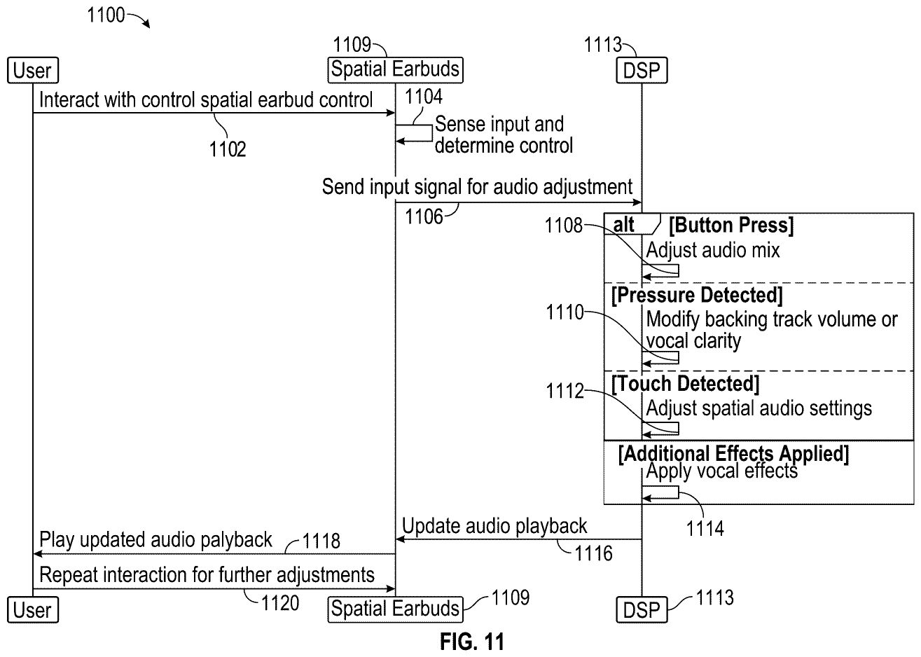

FIG. 10 is a sequence diagram 1000 for applying vocal effects to audio input, according to an example of an aspect of some embodiments of the present disclosure. In various embodiments, the individual steps of sequence diagram 1000 may be implemented by one or more components of the devices, systems, and/or methods of FIGS. 1-21 and may be performed in combination with any of the other processes and aspects described herein. Although the present disclosure may describe certain steps of sequence diagram 1000 (and of other processes described herein) as being implemented by certain components of the devices, systems, and/or methods of FIGS. 1-21, this is for purposes of illustration only. It should be understood that, e.g., other components of the devices, systems and methods of FIGS. 1-21 may implement those steps instead.

In some embodiments, at 1002, spatial earbuds 1009 (e.g., containing microphones designed for high-fidelity input) receive and capture a voice input from the user. In some embodiments, spatial earbuds 1009 may include noise-canceling capabilities (e.g., adaptive noise cancellation, beamforming microphones, etc.) to isolate the user's voice from ambient sounds. In some embodiments, at 1004, spatial earbuds 1009 transmit the isolated voice input to digital signal processor (DSP) 1013 to further refine the isolated voice input.

In some embodiments, at 1006 and 1008, DSP 1013 applies noise suppression techniques (e.g., signal normalization, spectral subtraction, echo cancellation, high-pass filter, low-pass filter, etc.) and vocal effects (e.g., reverb, echo, pitch correction, equalization, harmonization, etc.) to the isolated voice input. In some embodiments, the vocal effects are predetermined according to the original vocal effects of the vocal stem of the content item. In some embodiments the companion application 1011 may run on a companion device (e.g., user equipment 518 of FIG. 5) and provide an interface for configuring and controlling the vocal effects. For example, the companion application may provide a menu to select the desired vocal effects. In some embodiments, DSP 1013 may be embedded within spatial earbuds 1009 of a user device. In some embodiments, DSP 1013 may be part of an external companion device used to offload computationally heavy tasks. For example, DSP 1013 may perform voice isolation, noise suppression, and/or dynamic audio adjustments on an external server and return the output to the system.

In some embodiments, the system comprises advanced signal processing algorithms to implement the vocal effects. For example, the system may generate reverb and echo using convolution or algorithmic methods (e.g., to simulate acoustic environments). In another example, the system may adjust the voice input pitch to match the key of a content item using phase vocoding or time-domain pitch shifting. The system may also use equalization and harmonization to tailor the frequency response and add additional layers of sound that blend naturally with the original voice.

In some embodiments, at 1010, DSP 1013 returns enhanced audio comprising audio based on both the voice input and the applied audio effects to spatial earbuds 1009 and, at 1012, spatial earbuds 1009 output the enhanced audio through speakers of spatial earbuds 1009. For example, spatial earbuds 1009 may output enhanced audio with perceivably realistic spatial positioning of elements of the enhanced audio.

In some embodiments, at 1014, companion application 1011 receives user input to adjust effect parameters. For example, companion application 1011 may provide a menu of vocal effects parameters (e.g., reverb intensity, echo delay time, equalization frequency, equalization gain, harmonization spread, etc.) and/or predefined effect profiles (e.g., concert hall, studio, pop vocalist, etc.) in a GUI for selection. In some embodiments, the predefined effect profiles comprise parameter sets in the DSP (e.g., defining characteristics like reverb decay time, pitch correction thresholds, or equalization curves). In some embodiments, at 1016, companion application 1011 transmits updated parameters for vocal effects to DSP 1013. In some embodiments, at 1018, DSP 1013 adjusts the enhanced audio input according to the received updated parameters and returns the updated audio output to spatial earbuds 1009 for output at 1019.

In some embodiments, the system head-tracking is enabled to adjusted spatial positioning of the effects dynamically. For example, spatial earbuds 1009 may comprise IMUs or head-tracking sensors to dynamically determine and adjust the spatial positioning of the applied effects based on determined user movements. In some embodiments, at 1020, spatial earbuds 1009 may detect head movement and/or orientation and provide the determined direction, orientation, and/or position to DSP 1013. In some embodiments, at 1021, DSP 1013 adjusts the spatial positioning of the vocal effects dynamically and returns the updated audio output to spatial earbuds 1009 for output at 1023. Spatial earbuds 1009 may continue to monitor and provide DSP 1013 head-tracking data for continuous vocal effect update.

In some embodiments, the system utilizes spatial earbuds 1009 as a control interface through touch controls and/or voice commands, thus enabling hands-free operation.

In some embodiments, at 1022, spatial earbuds 1009 receive touch and/or voice inputs corresponding to vocal effect parameter controls. For example, touch and/or voice inputs may correspond to application of predefined effect profiles (e.g., concert hall, studio, pop vocalist, etc.). In some embodiments, the predefined effect profiles comprise parameter sets in the DSP (e.g., defining characteristics like reverb decay time, pitch correction thresholds, or equalization curves). In some embodiments, at 1024, spatial earbuds 1009 may transmit updated parameters for vocal effects to DSP 1013. In some embodiments, spatial earbuds 1009 communicate with DSP 1013 through companion application 1011. For example, spatial earbuds 1009 may be connected to companion application 1011 via Bluetooth or another wireless protocol. In some embodiments, at 1026, DSP 1013 adjusts the enhanced audio input according to the received updated parameters and returns the updated audio output to spatial earbuds 1009 for output at 1027. Additional details on spatial earbud controls are provided in sequence diagram 1100.

In some embodiments, the companion application 1011 may store (e.g., in storage circuitry 2008 of FIG. 20, storage circuitry 2114 of FIG. 21, storage circuitry 2122 of FIG. 21, or any other suitable storage) any custom vocal effects or vocal effect profile settings for subsequent use or modification.

FIG. 11 is a sequence diagram 1100 for audio control, according to an example of an aspect of some embodiments of the present disclosure. In various embodiments, the individual steps of sequence diagram 1100 may be implemented by one or more components of the devices, systems, and/or methods of FIGS. 1-21 and may be performed in combination with any of the other processes and aspects described herein. Although the present disclosure may describe certain steps of sequence diagram 1100 (and of other processes described herein) as being implemented by certain components of the devices, systems, and/or methods of FIGS. 1-21, this is for purposes of illustration only. It should be understood that, e.g., other components of the devices, systems and methods of FIGS. 1-21 may implement those steps instead.

In some embodiments, at 1102, spatial earbuds 1109 receive touch control corresponding to audio parameter controls that enable dynamic audio control through interaction with the earbuds. For example, touch controls on spatial earbuds 1109 simulate the behavior of singers using in-ear monitors to isolate their vocals for better monitoring. In some embodiments, spatial earbuds 1109 input controls and corresponding earbud interactions may be predefined and/or configurable in the companion application.

In some embodiments, at 1104, spatial earbuds 1109 may sense the touch control input and determine audio controls based on at least one of an interaction with a physical button, pressure sensing, capacitive-or impedance-based touch sensing, motion sensing (e.g., head gestures), and/or proximity sensing (e.g., using infrared light). For example, spatial earbuds 1109 may determine changes in pressure (e.g., when the earbud is pressed further into the ear canal) by receiving measurements of deformation or force changes on one or more surfaces of the earbud from small strain or force sensors. Spatial earbuds 1109 may determine contact with the earbud housing by receiving capacitance or impedance measurements of one or more electrodes (e.g., an increase in capacitance corresponds to touch, a decrease in impedance corresponds to touch, etc.). In some embodiments, at 1106, spatial earbuds 1109 may transmit the audio control signal to DSP 1113 for real-time processing.

In some embodiments, the control corresponding to a button press comprises adjusting the audio mix. For example, at 1108, DSP 1113 may adjust the audio mix (e.g., increase volume of a stem) based on a received button press of spatial earbuds 1109. In order to activate earbud button or touch controls, it may be necessary for the user to stop the gesture corresponding to the content item stem. In some embodiments, for example, in response to detecting disruption of a gesture corresponding to the content item stem, and determining a corresponding movement to adjust a user input control (e.g., detecting user movement toward the earbud or other control device), the system may, based on the configuration, continue to play the original stem audio output or the modified stem output based on the most recent determined gesture prior to detecting the disruption. For example, if a guitar stem tempo had been increased based on the user strum gesture and the system detects that the user stopped strumming to reach for the earbud to increase the volume, the system may sustain the increased guitar stem tempo output for a period of time. The system may continue outputting the stem audio for a configurable amount of time before it defaults to muting the stem or returning to the default audio stem settings.

In some embodiments, the control corresponding to pressure detection comprises modifying backing-track volume or vocal clarity based on the detected pressure. For example, at 1110, DSP 1113 may increase the gain of the voice input received by spatial earbuds 1109 relative to the backing tracks or lower instrumental stems to provide input-vocal clarity.

In some embodiments, the control corresponding to touch detection comprises adjusting spatial audio settings based on a detected touch. For example, at 1112, DSP 1113 may adjust the spatial audio settings (e.g., translating the spatial positioning of a stem) based on a received touch input of spatial earbuds 1109. For example, a sequence of touches (e.g., two taps, three taps, etc.) may select a particular instrument stem (e.g., guitar stem) and pressing and holding the right earbud may move the selected instrument stem to the right until the touch signal is released.

In some embodiments, additional effects, such as vocal effects, may be applied through custom controls configured in the companion application, as illustrated in the hands-free alternative of FIG. 10. For example, at 1114, proximity detection of spatial earbuds 1109 may apply effects (e.g., equalization, reverb, etc.) corresponding to the proximity of the input gesture.

In some embodiments, at 1116, DSP 1113 adjusts the audio playback according to the received earbud control and returns the updated audio playback to spatial earbuds 1009 for output at 1118.

In some embodiments, at 1120, spatial earbuds 1109 receive repeat interactions for further adjustments. For example, additional button presses may further increase the volume of an audio stem.

FIG. 12 illustrates an example of a synchronized exploration mode with audio spatial layout 1200, and FIG. 13 is a sequence diagram 1300 for synchronized exploration mode, according to an example of an aspect of some embodiments of the present disclosure. In various embodiments, the individual steps of sequence diagram 1300 may be implemented by one or more components of the devices, systems, and/or methods of FIGS. 1-21 and may be performed in combination with any of the other processes and aspects described herein. Although the present disclosure may describe certain steps of sequence diagram 1300 (and of other processes described herein) as being implemented by certain components of the devices, systems, and/or methods of FIGS. 1-21, this is for purposes of illustration only. It should be understood that, e.g., other components of the devices, systems and methods of FIGS. 1-21 may implement those steps instead.

In some embodiments, the synchronized exploration mode enables users to experience an immersive audio journey of a content item (e.g., of a concert or classical performance) having a dynamic spatial audio environment (e.g., as illustrated in FIG. 12) created by a spatial arrangement of various audio stems. In some embodiments, synchronized exploration mode follows a pre-arranged spatial “flight path” (e.g., flight path 1250 with nodes 1202-1224). In some embodiments, synchronized exploration mode may be explored using interactive user controls (e.g., head tracking, gestures, earbud controls, etc.) received via earbuds (e.g., headphones 514 of FIG. 5), wearable sensors (e.g., wearable sensors 516 of FIG. 5) and/or a user device (e.g., user equipment 518 of FIG. 5).

In some embodiments, the system utilizes advanced spatial audio rendering to create realistic acoustic environments that are adapted according to a virtual position of the user in an audio landscape (e.g., audio spatial layout 1200 of FIG. 12). By way of illustration, the user may select, or be assigned, a virtual position in a virtual concert hall with a philharmonic orchestra. For example, the system may make real-time adjustments to volume, balance, and reverb to replicate the acoustics of specific simulated areas (e.g., the resonant clarity of the front row, the diffuse ambiance of a balcony seat, etc.) where the virtual user may be virtually located. In pre-arranged flight mode, for example, the system may choreograph acoustic changes to match the narrative of the content item as it progresses. In user-controlled mode, for example, the system may respond directly to the input controls (head movement, gesture input, etc.) of the user transitioning through the acoustic layout.

In some embodiments, in FIG. 13, at 1302, companion application 1311 receives a selection of a fly-through-compatible content item and fly-through mode (e.g., pre-arranged, user-controlled, or multi-user) and, at 1304, returns content item metadata and settings to system 1305.

In some embodiments, at 1306, system 1305 initializes spatial audio rendering of the selected content item at spatial audio engine 1317.

In some embodiments, for example in user-controlled mode, at 1308, system 1305 activates head tracking of spatial earbuds 1309.

In some embodiments, synchronized exploration mode comprises a pre-arranged flight mode. For example, in the pre-arranged flight mode, the system synchronizes spatial audio adjustments with the temporal progression of the content item.

In some embodiments, at 1310, system 1305 executes pre-mapped spatial transitions via spatial audio engine 1317 during the play of the content item. In some embodiments, at 1312, spatial audio engine 1317 updates the spatial audio perspective output of spatial earbuds 1309 dynamically based on the pre-mapped spatial transitions and, at 1314, spatial earbuds 1309 play the dynamically adjusted spatial audio.

For example, a classical symphony orchestral content item may have audio spatial layout 1200 of FIG. 12 and pre-arranged flight path 1250 that causes the system to adjust the spatial arrangement of the instrument stems according to the current node (e.g., nodes 1202-1224) of the progressing flight path 1250. For example, the system may begin playback of the orchestral content item with the spatial audio perspective heard as if the user were standing at the conductor's podium (e.g., node 1202) with violins sounding from the left, cellos sounding from the right, etc. As the orchestral content item progresses, the system transitions the spatial arrangement according to the flight path 1250. For example, flight path 1250 progresses from node 1202 to node 1204 to node 1206, etc. In some embodiments, the pre-arranged flight path may transition from one section to another section based on the focus or key elements of the orchestral content item. For example, the flight path may transition to first violin section at node 1204 during a solo, transition to the brass section at node 1220 during a crescendo, and transition to the percussion area at node 1216 during a climactic finale.

In some embodiments, synchronized exploration mode comprises a user-controlled flight mode. For example, in the user-controlled flight mode, the system receives user controls via head-tracking (e.g., via head-tracking engine 544), input gestures (e.g., via gesture detection engine 524), and/or earbud controls (e.g., via earbud control 546) to navigate through the spatial environment interactively. In some embodiments, navigation controls may be configured through a companion application.

In some embodiments, at 1316, spatial earbuds 1309 track user head movements and, at 1318, communicate the captured head-tracking input to system 1305. For example, spatial earbuds 1309 may comprise IMUs or head-tracking sensors to dynamically determine and adjust the spatial positioning of the content item audio stems based on determined user head movements. In some embodiments, at 1320, system 1305 may determine the head movement and/or orientation of the input and provide the determined direction, orientation, and/or position to spatial audio engine 1317 to adjust spatial positioning of the content item audio stems. In some embodiments, at 1322, spatial audio engine 1317 returns the updated spatial audio output based on movement to spatial earbuds 1309 for output, at 1324. Spatial earbuds 1309 may continue to monitor and provide spatial audio engine 1317 head-tracking data via the system for continuous spatial audio updates.

For example, the system may use head-tracking for navigation where the system, determining a virtual position of the user at, for example, conductor node 1202, may receive a head tilt to the left to move the virtual user position to first violin node 1204 or may receive a head tilt to the right to move the virtual user position to cello node 1224. In some embodiments, the spatial layout is continuous, where navigation can be anywhere within the spatial layout (e.g., not just at nodes) based on the user input. For example, the system, determining a user at, for example, conductor node 1202, may receive a head tilt forward to move the audio perspective between the second violin node 1212 and the viola node 1218. In some embodiments, the system updates the spatial arrangement of stems based on determining a change in head orientation. For example, the system, determining a user at, for example, conductor node 1202 facing percussion node 1216, will provide a spatial arrangement where piano sounds come from the left-hand side and double bass sounds come from the right-hand side, and upon determining the user is facing away from percussion node 1216 will provide an inverted spatial arrangement where piano sounds come from the right-hand side and double bass sounds come from the left-hand side. The system interprets input gestures in real time, dynamically adjusting the spatial audio mix to match the corresponding virtual user movement. In some embodiments, the system applies predictive filtering to smooth changes in spatial positioning, ensuring that the audio remains coherent, immersive, and without abrupt transitions as the system receives inputs.

In some embodiments, for example, when the system determines the virtual user location corresponds with conductor node 1202, the system may automatically enter conductor mode to monitor for user gestures indicating a conductor role while the content item is being played. In conductor mode, the system may control the spatial audio mix of a content item by determining simulated conductor gestures. For example, the system may track arm, wrist, hand, and/or finger gestures (e.g., via wearable sensors 516 and/or user equipment 518 of FIG. 5) to determine movements or features of movements (e.g., linear acceleration, angular velocity, etc.) corresponding to content spatial audio control. In some embodiments, the system may determine wrist movements corresponding to traditional conductor motions that cause the system to raise the intensity or slow the tempo of one or more orchestral stems. For instance, the system may trigger a crescendo when the system determines a quick upward flick of a wrist, or the system may slow the tempo when the system determines a downward motion of a wrist. In some embodiments, the system may determine that a head movement corresponds to the head turning toward brass node 1220 of FIG. 12 and, in response, increases the prominence of the brass stem in the spatial audio mix. In another example, the determined head movement may select the audio stem in the direction of the head movement and the system adjusts the audio of the selected stem based on an additional gesture (e.g., hand movement, wrist movement, arm movement, etc.). In some embodiments, for example, when the system determines the virtual user location departs from conductor node 1202, the system may automatically exit conductor mode.

In some embodiments, the system may support multi-user synchronization, wherein multiple users can share the same fly-through experience simultaneously. For example, the system may provide personalized spatial audio of a content item relative to the respective virtual position of each user within the audio landscape, thus providing a tool for collaborative or educational settings (e.g., guided tours of iconic concert halls, symphony analyses, etc.).

In some embodiments, at 1326, companion application 1311 may receive a request to initiate or join a shared fly-through session. In some embodiments, at 1328, companion application 1311 may provide the virtual position of the joining user to system 1305 and, at 1330, system 1305 provides the virtual positions of all users of the fly-through session to spatial audio engine 1317 to align the spatial perspective for all users. In some embodiments, at 1332 spatial audio engine 1317 provides the synchronized spatial audio playback to spatial earbuds 1309 and, at 1334, spatial earbuds 1309 play the synchronized spatial audio.

In some embodiments, to enhance the experience, a companion application may be used in synchronized exploration mode to select between pre-arranged and user-controlled modes, navigate the audio spatial layout, and configure gesture input controls.

For example, in some embodiments, at 1336, companion application 1311 may receive input to adjust sensitivity (e.g., of head-tracking, input gestures, etc.) or toggle modes (e.g., pre-arranged and user-controlled modes). For example, the companion application may provide a visual interface (e.g., GUI) that displays the virtual position (e.g., via an indicator, an icon, a picture, an avatar, etc.) of the user within the virtual environment. The companion application may also be used to configure the sensitivity of head tracking (e.g., for fine or broad movements) and customize flight paths for future playback. In some embodiments, at 1338, companion application 1311 may provide the updated settings to system 1305 and, at 1340, system 1305 provides the new configuration to spatial audio engine 1317 to utilize for subsequent audio adjustments at 1342.

In some embodiments, the companion application may provide a selection of preloaded fly-throughs (e.g., content items with pre-arranged spatial audio) curated by artists, conductors, or venue designers, allowing users to explore performances as envisioned by professionals. For example, Tchaikovsky's “Nutcracker Suite” may be a selectable fly-through concert, including visual content, wherein the system positions the virtual user near the celesta and strings during the “Dance of the Sugar Plum Fairy,” thus capturing the delicate tones that mirror the light, graceful movements of the dancers. As the performance transitions to the “Russian Dance (Trepak),” the system moves the user virtually to the percussion and brass sections, aligning with the energetic choreography and bold musical motifs. During the “Waltz of the Flowers,” the system translates the user virtually across the orchestra, thus blending the audio spatial experience with the sweeping melodic lines and capturing the grandeur of the ensemble. In this example, the system may also align the spatial positioning of the audio to follow the spatial choreography of a dancer on a stage to provide an immersive experience where the audio perspective aligns with the visual flow of the ballet. The system may incorporate an application that provides a visual experience of the fly-through using virtual reality equipment, such as a head-mounted device (HMD) or other extended reality (XR) equipment. For example, the user wearing the XR HMD may be shown the corresponding orchestra sections and individual musicians and instruments from the user vantage points according to the fly-through as the user listens to the orchestra as discussed above. The visual experience may be generated by generative AI or may be provided based on stored image data.

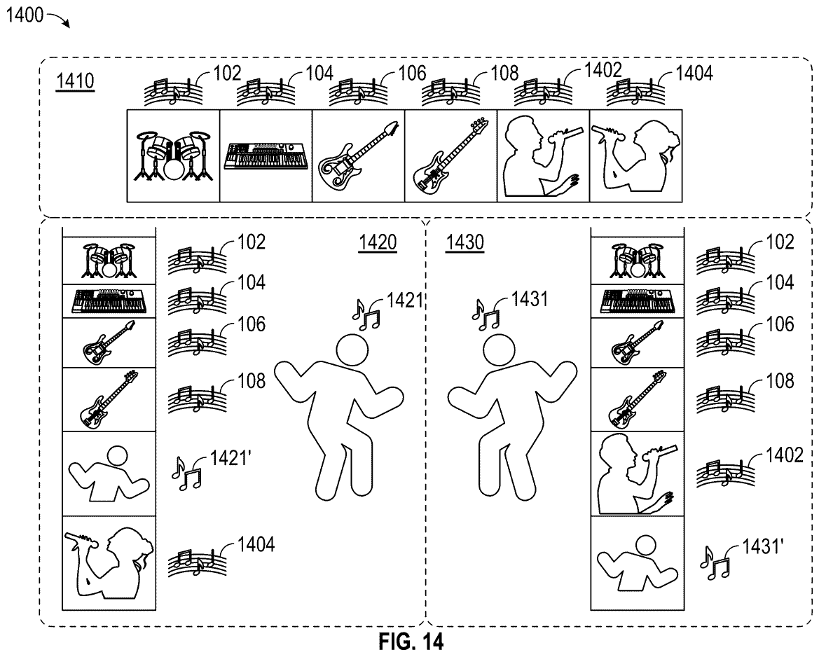

FIG. 14 illustrates an example of a duet mode 1400, according to an example of an aspect of some embodiments of the present disclosure.

In some embodiments, for example, when a content item (e.g., content item 1410) comprising duet vocals (e.g., vocal stem 1402 and vocal stem 1404) has been selected for playback, the system may enter a duet mode. In duet mode, the system may support one or more users (e.g., co-located or remote from each other) performing the content item with duet vocals. For example, the companion application of the system may be used to identify duet vocal stems 1402 and 1404 of content item 1410 for selection to perform. Based on the duet stem vocal selection, the system may suppress (e.g., reduce the volume) or remove only the chosen vocal stem, leaving the other vocal stem playing. For example, in duet mode for content item 1420, the system receives a selection to perform vocal stem 1402 and, based on this selection, the system suppresses or removes vocal stem 1402 and replaces vocal stem 1402 with audio based on user vocal data 1421′ as the user performs and the system receives vocal data 1421 to integrate with audio stems 102-108 and 1404 to generate content item 1420 for output. Similarly, for example, in duet mode for content item 1430, the system receives a selection to perform vocal stem 1404 and, based on this selection, the system suppresses or removes vocal stem 1404 and replaces vocal stem 1404 with audio based on user vocal data 1431′ as the user performs and the system receives vocal data 1431 to integrate with audio stems 102-108 and 1402 to generate content item 1430 for output. In some embodiments, the system spatially positions the remaining duet vocals to simulate a live duet experience. For example, the system may position vocal stem 1404 to the side of, or moving around, audio based on user vocal data 1421′. In some embodiments, the system may adapt the spatial positioning based on determining user movements and/or orientation (e.g., via head-tracking). For example, if the system determines the user has moved past the virtual audio position of vocal stem 1404, the system may adjust vocal stem 1404 to sound as though it is coming from the opposite direction after the movement.

In some embodiments, the system may automatically determine duet mode by determining that vocal data corresponds with a vocal stem of a duet content item.

In some embodiments, the companion application may be used to configure duet mode. For example, the companion application may be used to configure fine control over spatial positioning and vocal blending through interface and/or voice commands. For instance, the companion application may be used to customize the prominence and location of the accompanying vocal and instrument stems and/or the vocal effect of audio based on user vocal data, creating an immersive and engaging duet performance. In some embodiments, the companion application may be configured so that the system outputs audio based on user vocal data (e.g., audio based on the user vocal data 1421′ and audio based on the user vocal data 1431′) for both duet stems for users concurrently performing the duet to hear both performances.

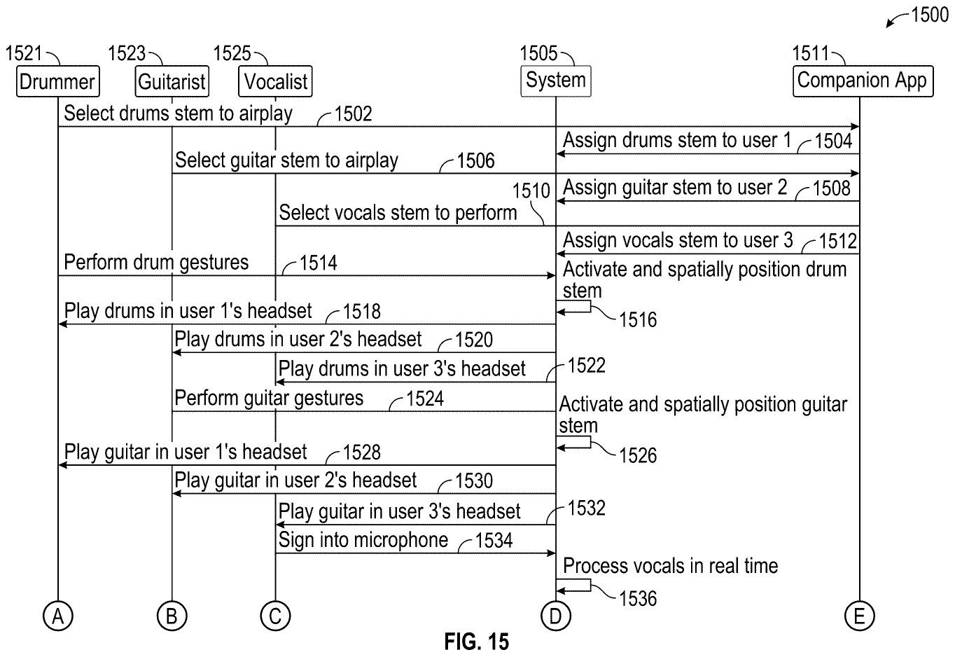

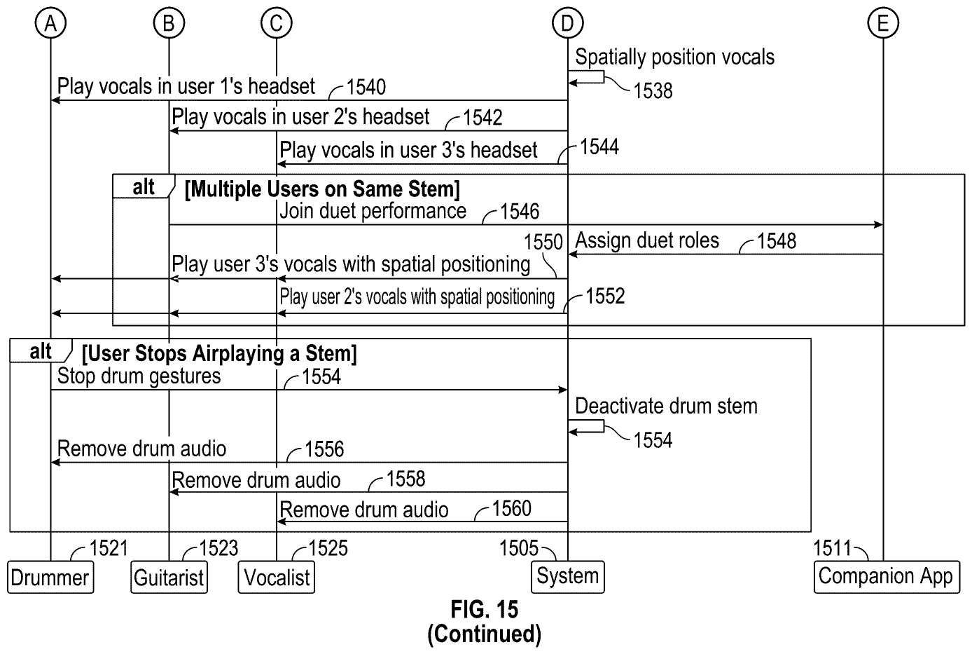

FIG. 15 is a sequence diagram 1500 for band mode, according to an example of an aspect of some embodiments of the present disclosure. In various embodiments, the individual steps of sequence diagram 1500 may be implemented by one or more components of the devices, systems, and/or methods of FIGS. 1-21 and may be performed in combination with any of the other processes and aspects described herein. Although the present disclosure may describe certain steps of sequence diagram 1500 (and of other processes described herein) as being implemented by certain components of the devices, systems, and/or methods of FIGS. 1-21, this is for purposes of illustration only. It should be understood that, e.g., other components of the devices, systems and methods of FIGS. 1-21 may implement those steps instead.

In some embodiments, band mode is a collaborative environment where the system integrates user air-instrument playing and/or singing into one spatially arranged content item for playback in real time. For example, the system may receive a first user selection to air-play the drums, a second user selection to air-play the guitar and a third user selection to perform the vocals. In some embodiments, each user has a playback device and spatial headsets. In some embodiments, each user may be co-located or remote.

In some embodiments, steps 1502-1512 comprise setting up stem assignments of band mode via the companion application. For example, at steps 1502, 1506, and 1510, companion application 1511 receives selection of the drum stem from drummer 1521, selection of the guitar stem from guitarist 1523, and selection of the vocal stem from vocalist 1525, respectively. At steps 1504, 1508, and 1512, companion application 1511 provides the respective stem assignments to system 1505.

In some embodiments, steps 1514-1544 comprise performing in band mode. In some embodiments, steps 1514-1522, steps 1524-1532, and steps 1534-1544 occur substantially simultaneously.

For example, at 1514, system 1505 determines drum gestures corresponding to the drum stem. At 1516, system 1505 activates and spatially positions the drum stem. At 1518-1522, system 1505 plays the drum stem corresponding to the movements of drummer 1521 in the headset of each respective user.

For example, at 1524, system 1505 determines guitar gestures corresponding to the guitar stem. At 1526, system 1505 activates and spatially positions the guitar stem. At 1528-1532, system 1505 plays the guitar stem corresponding to the movements of guitarist 1523 in the headset of each respective user.

For example, at 1534, system 1505 receives, via a microphone, voice data corresponding to the vocal stem. At 1536, system 1505 processes (e.g., filters, applies special effects, etc.) the voice data in real time and, at 1538, spatially positions the vocal stem based on the voice data. In some embodiments, companion application 1511 may be used to configure the voice processing setting and/or effects. At 1540-1544, system 1505 plays the vocal stem based on the voice data of vocalist 1525 in the headset of each respective user.

In some embodiments, steps 1546-1552 comprise performing in band mode with dual roles (e.g., duet vocals). This embodiment is not limited to vocals and may also be applied via generating two user-controlled instrument stems for playback in each headset of the participants. For example, at 1546, the companion application determines that guitarist 1523 has joined the duet vocal performance (e.g., through pre-selection of both roles or through determining guitarist 1523 voice data corresponds with one of the duet stems). At 1548, companion application 1511 provides the duet role assignments to system 1505. At 1550 and 1552, system 1505 plays the vocal stems based on the voice data of each vocalist in the headset of each respective user.

In some embodiments, steps 1554-1560 comprise the system determining that gestures for an instrument stem has stopped. For example, at 1554, system 1505 determines that drummer 1521 has stopped making drumming gestures. At 1556, system 1505 deactivates the drum stem and as a result removes drum stem audio from respective user headset at steps 1556-1560.

In some embodiments, band mode may be configured to be in a practice mode, wherein the playback speed of an audio stem is based on the air-play rhythm of a user. For example, the system may determine the beat speed of a user air-playing an instrument and determine the correlation to the original beat of the associated stem. In an example, the system may assign the singer as the beat control stem so that if the user is singing faster or slower than in the original voice stems, the system may notify the air players and/or the singer of the discrepancy. In this mode, the air players and the singer all need to perform in sync for the associated audio stems to be all played in sync as well.

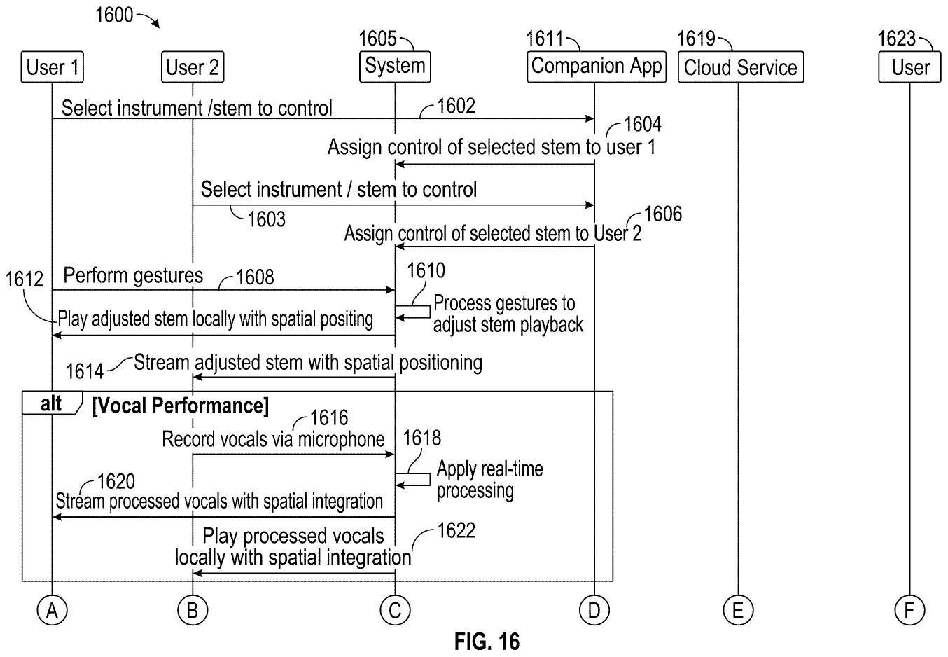

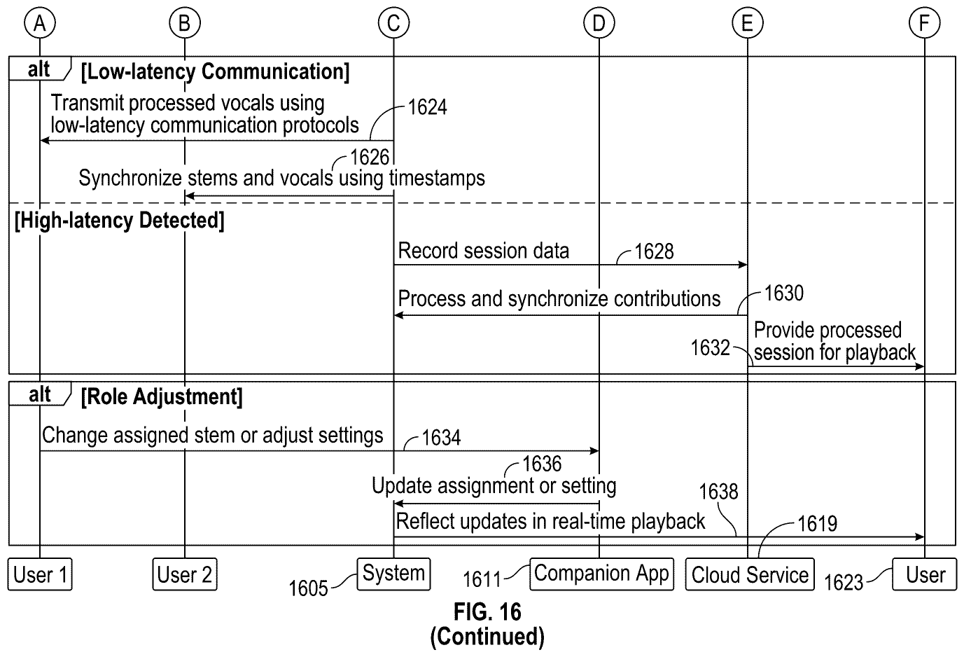

FIG. 16 is a sequence diagram 1600 for remote collaboration mode, according to an example of an aspect of some embodiments of the present disclosure. In various embodiments, the individual steps of sequence diagram 1600 may be implemented by one or more components of the devices, systems, and/or methods of FIGS. 1-21 and may be performed in combination with any of the other processes and aspects described herein. Although the present disclosure may describe certain steps of sequence diagram 1600 (and of other processes described herein) as being implemented by certain components of the devices, systems, and/or methods of FIGS. 1-21, this is for purposes of illustration only. It should be understood that, e.g., other components of the devices, systems and methods of FIGS. 1-21 may implement those steps instead.

In some embodiments, the system enables duet and collaboration features for remote users, allowing multiple participants in different locations to participate together in performing roles of a content item in a synchronized and interactive manner. For instance, the system may enable remote collaboration mode when at least one user selects a content item including audio stems (e.g., drums, bass, vocals, guitar, etc.) for remote collaboration. In some embodiments, a session may be private (e.g., invitation to join required) or public (e.g., anyone may join or request to join). In some embodiments, a companion application may be used to select stem roles to perform, and a user device and/or wearable sensors may be used to determine user inputs. For example, the system may determine user inputs (e.g., voice input, head tracking, gesture tracking, etc.) from each user and dynamically control each corresponding audio stem to generate an integrated audio content to play back for all users. For instance, the system may determine that the movements of one user correspond to air-playing a guitar through detecting strumming motions of the smartphone of the user. In another example, the system may determine that the movements of another user correspond to air-playing drums through detecting tapping gestures through a smartwatch of the user. In some embodiments, the system spatially positions and mixes each participant stem to create a cohesive auditory experience and may dynamically adjust the spatial arrangement of the audio based on movements of the participating users.

In some embodiments, steps 1602-1606 comprise setting up stem assignments of remote collaboration mode via the companion application. For example, at steps 1602 and 1603, companion application 1611 receives selection of instrument stems (e.g., drums, bass, guitar, etc.) from user 1 and user 2, respectively. At steps 1604 and 1606, companion application 1611 provides the respective stem assignments to system 1605.

In some embodiments, steps 1608-1614 comprise performing in remote collaboration mode. For example, at 1608, system 1605 determines that the arm gestures of user 1 correspond to a musical pattern (e.g., strumming, tapping, etc.). At 1610, system 1605 processes the gestures to adjust the selected stem playback (e.g., corresponding to the movements of user 1). In some embodiments, at 1612, system 1605 plays the adjusted stem locally with spatial positioning for user land, at 1614, system 1605 streams the adjusted stem with spatial positioning for user 2.

In some embodiments, steps 1616-1622 comprise the steps associated with at least one user selecting a vocal stem for remote collaboration mode via the companion application. For example, at 1616, system 1605 records the vocals of user 2 via a microphone (e.g., microphone 512 of FIG. 5). In some embodiments, at 1618, system 1605 applies real-time processing (e.g., filtering, reverb, pitch correction, etc.) to the voice input. In some embodiments, companion application 1611 may be used to configure the voice processing setting and/or effects (e.g., tailored to the content item or customized). In some embodiments, at 1620, system 1605 streams the processed vocals with spatial integration for user 1 and, at 1622, system 1605 plays the process vocals locally with spatial integration for user 2. For example, the system may position the processed vocals centrally and position the instrumental stems to be distributed around the processed vocals. In some embodiments, the system may facilitate real-time recording, low-latency transmission, and processing of the voice of the user, thus seamlessly integrating audio based on the voice of the user with the spatial audio playback for all users. In some embodiments, for example, where the system determines that transmission latency exceeds an acceptable threshold (e.g., more than 100 ms), the system may record the session in the cloud, thus enabling playback and review at a later time, as described in more detail below.

In some embodiments, steps 1624-1632 comprise processes for transmitting performances of remote collaboration mode. For example, steps 1624-1626 correspond to low-latency communication, and steps 1628-1632 correspond to communication during high latency.

In some embodiments, vocal data is captured via a microphone (such as at step 1616), processed (such as at step 1618), and, at step 1624, system 1605 transmits the processed vocals to each participate (e.g., user 1, user 2, etc.) using low-latency communication protocols (e.g., WebRTC, QUIC, a combination of both or proprietary UDP-based protocols optimized for minimal jitter and delay). In some embodiments, the system utilizes packet prioritization, adaptive bitrate encoding, and forward error correction to minimize disruptions in audio quality and reduce latency. In some embodiments, at 1626, the system synchronizes the transmitted audio with the other stems using time-stamped packets and buffer management to ensure that the vocals are aligned with the ongoing performance.

In some embodiments, for example, at 1628, where system 1605 determines that transmission latency exceeds an acceptable threshold (e.g., more than 100 ms) for real-time collaboration, system 1605 may record session data (e.g., gestures, stems, vocals, etc.) in cloud service 1619. For example, system 1605 may upload the contributions, including gestures, vocal recordings, and instrument control data, of each participant to be synchronized with the timeline of the content item by cloud service 1619. In some embodiments, at 1630, cloud service 1619 returns the processed and synchronized contribution to system 1605. In some embodiments, at 1632, cloud service 1619 may provide the processed session for playback to additional users (e.g., via a streaming platform, social media, text messaging, email, etc.).

In some embodiments, steps 1634-1638 comprise role and/or settings adjustments in remote collaboration mode. For instance, the system may enable a user to choose to perform a specific instrument, select effect presets for their vocals, and/or adjust the sensitivity of gesture detection. For example, at 1634, companion application 1611 may receive a role and/or settings adjustment through an interface of a user device. At 1636, companion application 1611 may provide the updated role assignment and/or setting adjustment (e.g., gesture sensitivity) to system 1605. In some embodiments, at 1638, system 1605 outputs the reflected updates in real-time playback through user devices. In some embodiments, companion application 1611 provides real-time feedback on the collaboration, including visual indicators of stem activation, participant contributions, and session latency.

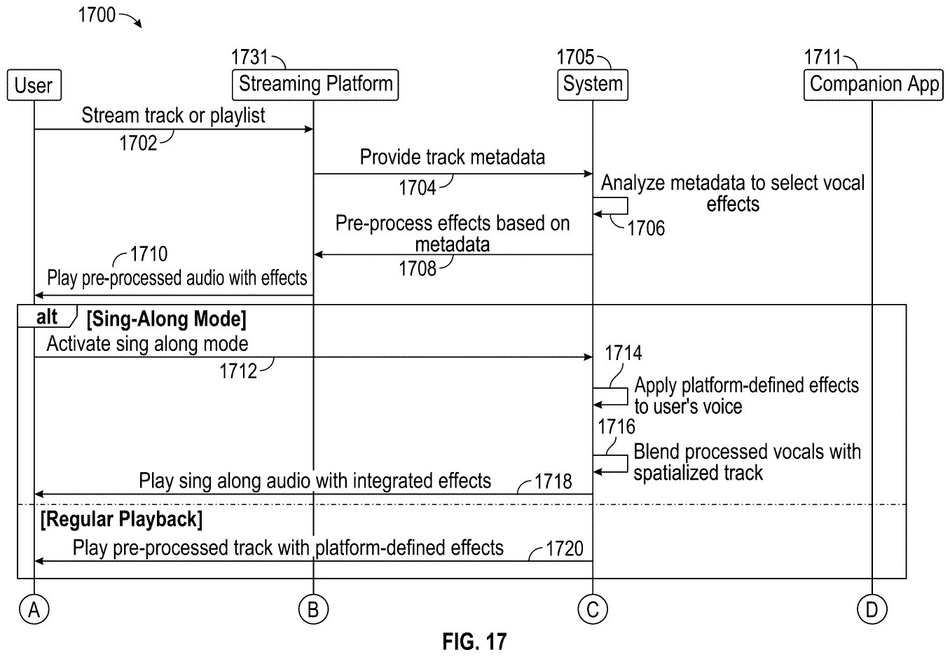

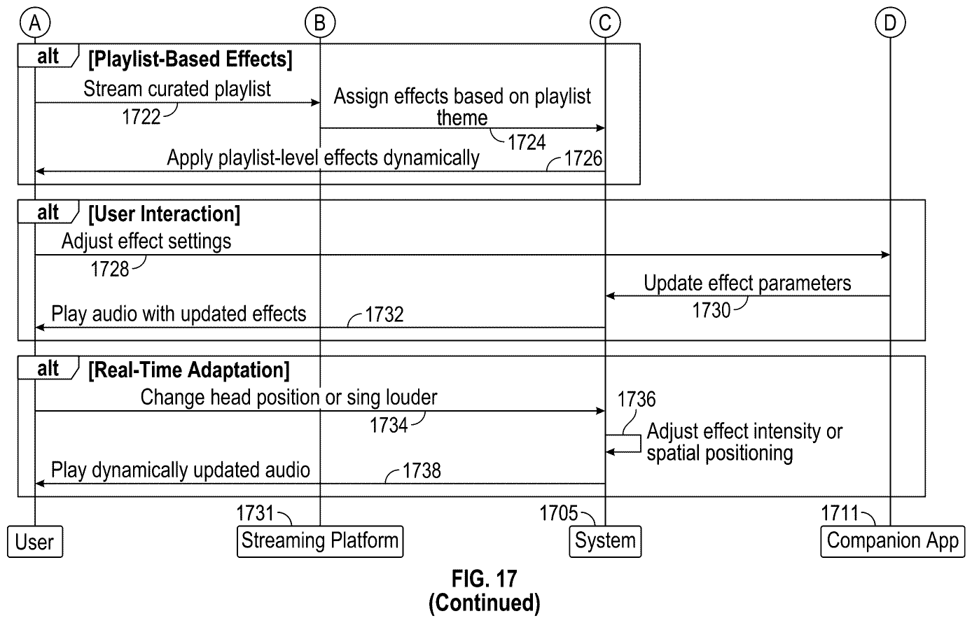

FIG. 17 is a sequence diagram 1700 for streaming platform effects mode, according to an example of an aspect of some embodiments of the present disclosure. In various embodiments, the individual steps of sequence diagram 1700 may be implemented by one or more components of the devices, systems, and/or methods of FIGS. 1-21 and may be performed in combination with any of the other processes and aspects described herein. Although the present disclosure may describe certain steps of sequence diagram 1700 (and of other processes described herein) as being implemented by certain components of the devices, systems, and/or methods of FIGS. 1-21, this is for purposes of illustration only. It should be understood that, e.g., other components of the devices, systems and methods of FIGS. 1-21 may implement those steps instead.

In some embodiments, the system may enable personalized audio effects integration through a music streaming platform (e.g., Spotify). For example, the system may pre-process spatial environments for streaming platform tracks and provide platform-defined vocal effects tailored to specific songs or playlists. Thus, the system may enhance the interactive audio experience of a streaming platform by aligning the effects with the musical style, era, or mood of the content item being played.

In some embodiments, at 1702, streaming platform 1731 may receive a request to stream a track or playlist. At 1704, streaming platform 1731 may provide the track or playlist metadata (e.g., genre, era, tempo, instrumentation, etc.) to system 1705. In some embodiments, at 1706, system 1705 may analyze the metadata to determine vocal effects to apply to the track or playlist. For example, the system may analyze the track or playlist genre, release era, tempo, and instrumentation to determine the most suitable vocal effects. For instance, the system may determine that applying a tailored echo effect to a 1960s psychedelic track would complement the characteristic sound of that era. In another example, the system may determine that applying a smooth reverb to simulate a large studio environment would be suitable for a modern pop ballad. In some embodiments, at 1708, system 1705 optimizes and pre-processes these predefined effects on the servers of the streaming platform to ensure consistent quality and low device processing requirements. In some embodiments, at 1710, streaming platform 1731 may play the pre-processed audio with effects, for example, through a user device (e.g., user equipment 518).

In some embodiments, steps 1712-1720 comprise a sing-along mode through a streaming platform. For example, at 1712, system 1705 may receive user input to activate sing-along mode. In some embodiments, user input may be via the companion application or may be through system determination that user voice data corresponds with a vocal stem of the track (e.g., via sing-along detection engine 522 of FIG. 5). In some embodiments, at 1714, system 1705 may apply platform-defined effects to the user voice input received via a microphone of a user device and, at 1716, system 1705 may blend the processed vocals with the spatialized track. For example, when the system determines that the track genre is '80s new wave, the system may automatically apply chorus and gated reverb effects to the vocal input to match the sonic character of the original recording. The system then synchronizes the effects with the tempo and key of the track to maintain a cohesive auditory experience. In some embodiments, at 1718, system 1705 plays the sing-along audio with integrated effects (e.g., via headphones 514 of FIG. 5). In some embodiments, system 1705 may determine that the user has exited sing-along mode (e.g., via the companion application or determining the voice input has stopped), and, at 1720, system 1705 may revert to playing the pre-processed track with platform-defined effects of regular playback mode.

In some embodiments, steps 1722-1726 comprise applying playlist-based effects through a streaming platform. For example, in addition to applying effects at a song level, the system may extend this capability to playlists of a streaming platform by assigning effects based on the overall theme or mood. In some embodiments, at 1722, streaming platform 1731 may receive a request to stream a curated playlist. For example, the curated play list may be a “Golden Oldies” playlist. In some embodiments, at 1724 streaming platform 1731 may provide the assigned effects for system 1705 to apply during the play of the playlist. For example, the assigned effects for the “Golden Oldies” playlist may include a slap-back echo or warm analog distortion. In another example, the assigned effects for a “Chill Electronica” playlist may include subtle delays and ambient reverb to create a soothing atmosphere. In some embodiments, at 1726, system 1705 may apply playlist level effects dynamically and provide the processed audio for output.

In some embodiments, steps 1728-1732 comprise updating effects of a streaming platform based on user interactions. For example, the companion application may be used to toggle between default platform effects and customized settings. In some embodiments, this control is accessed through the streaming interface of the streaming platform. In some embodiments, at 1728, companion application 1711 may receive user input (e.g., via voice, GUI, gesture, etc.) to adjust effect settings (e.g., reverb intensity echo delay time, equalization frequency, equalization gain, harmonization spread, etc.). In some embodiments, at 1730, companion application 1711 provides the updated effect parameters to system 1705, and, at 1732, system 1705 plays the audio with updated effects. In some embodiments, the streaming platform may store (e.g., in storage circuitry 2008 of FIG. 20, storage circuitry 2114 of FIG. 21, storage circuitry 2122 of FIG. 21, or any other suitable storage) any custom effects or effect profile settings for subsequent use or modification.

In some embodiments, steps 1734-1738 comprise real-time adaptation of audio playback from a streaming platform. In some embodiments, at 1734, system 1705 may receive user input (e.g., change of head position, change of singing volume, arm gesture, etc.). In some embodiments, at 1736, system 1705 may adjust an effect intensity or spatial positioning of the audio based on the received user input, and, at 1738, system 1705 may play the dynamically updated audio. For example, the system may modulate the intensity or spatial positioning of an echo or reverb effect in real time to reflect the changes determined in the user performance. In some embodiments, the companion application may be used to override the suggested effects or deactivate user interaction effects.

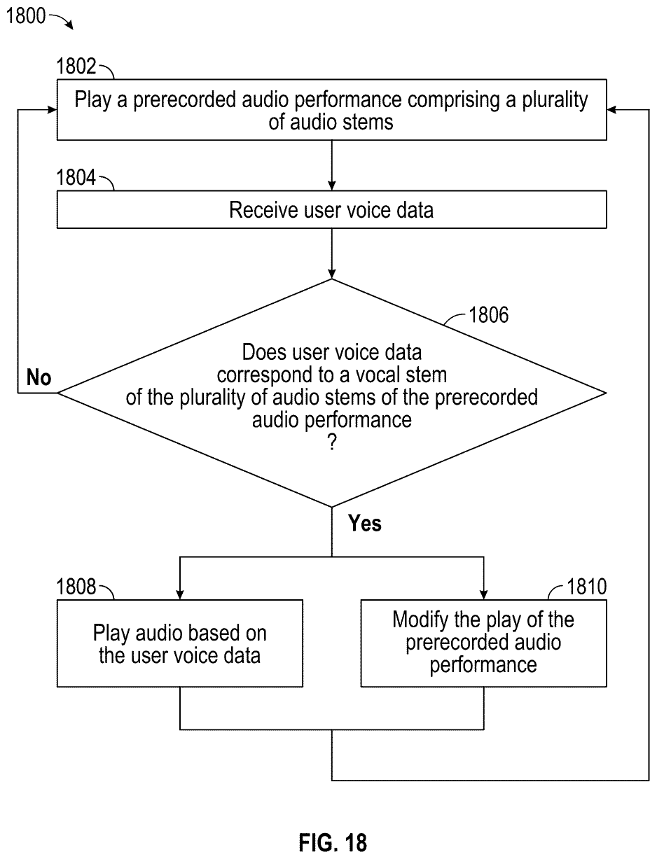

FIG. 18 is a flowchart 1800 that illustrates a process for modifying a prerecorded audio performance based on corresponding user voice data, according to an example of an aspect of some embodiments of the present disclosure. In various embodiments, the individual steps of process 1800 may be implemented by one or more components of the devices, systems, and/or methods of FIGS. 1-21 and may be performed in combination with any of the other processes and aspects described herein. Although the present disclosure may describe certain steps of process 1800 (and of other processes described herein) as being implemented by certain components of the devices, systems, and/or methods of FIGS. 1-21, this is for purposes of illustration only. It should be understood that, e.g., other components of the devices, systems and methods of FIGS. 1-21 may implement those steps instead.

In some embodiments, at step 1802, the system plays a prerecorded audio performance comprising a plurality of audio stems (e.g., drum stem, keyboard stem, guitar stem, bass stem, vocal stem, etc.). For example, the prerecorded audio performance may be a content item, audio recording, video recording, etc. For example, at step 1804, the microphone may receive user voice data. In some embodiments, at step 1806, the system determines whether the user voice data corresponds to a vocal stem of the plurality of audio stems of the prerecorded audio performance. For example, the system may use one or more ML models and/or algorithms to determine a confidence score based on phoneme similarity, melody alignment, and/or tempo synchronization. If the confidence score is below a predetermined threshold, the system determines the user voice data does not correspond with the vocal stem of the prerecorded audio performance and reverts to step 1802. If the confidence score meets or is above a predetermined threshold, the system determines the user voice data does correspond with the vocal stem of the prerecorded audio performance and proceeds to steps 1808 and 1810, which may occur substantially simultaneously. For example, at step 1808, the system may play audio based on the user voice data. In some embodiments, at step 1810, the system may modify the play of the prerecorded audio performance. For example, modifying the play of the prerecorded audio performance may include decreasing a volume level of or muting the vocal stem. The process returns from steps 1808 and 1810 to step 1802. In some embodiments, for example, if the system determines the voice input corresponding to the vocal stem of the prerecorded audio performance stops, the system will revert to playing the vocal stem at the original volume level.

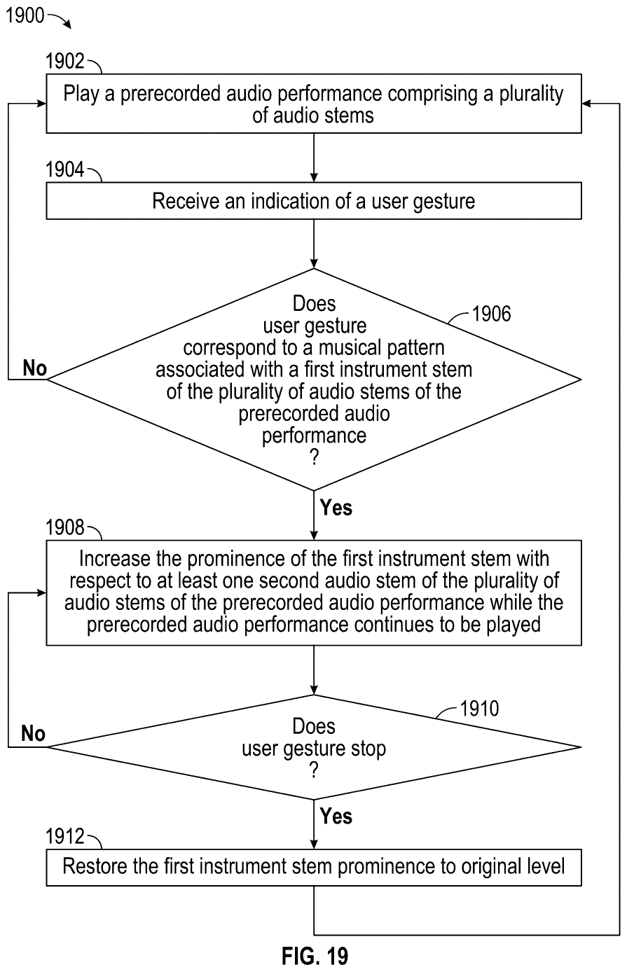

FIG. 19 is a flowchart 1900 that illustrates a process for modifying a prerecorded audio performance based on corresponding user gesture data, according to an example of an aspect of some embodiments of the present disclosure. In various embodiments, the individual steps of process 1900 may be implemented by one or more components of the devices, systems, and/or methods of FIGS. 1-21 and may be performed in combination with any of the other processes and aspects described herein. Although the present disclosure may describe certain steps of process 1900 (and of other processes described herein) as being implemented by certain components of the devices, systems, and/or methods of FIGS. 1-21, this is for purposes of illustration only. It should be understood that, e.g., other components of the devices, systems and methods of FIGS. 1-21 may implement those steps instead.

In some embodiments, at step 1902, the system plays a prerecorded audio performance comprising a plurality of audio stems (e.g., guitar, bass, drums, piano, harp, trumpet, trombone, saxophone, etc.). The user may hold a stylus that tracks hand movement and/or the system may comprise one or more sensors, for example, electrodes, optical emitters and detectors, microphones, thermometers, thermistors, pressure sensors, respiratory sensors, eye-tracking sensors, video oculography (VOG) systems, facial tracking systems, cameras (including, for example, video cameras, infrared cameras, or thermal cameras), motion sensors, accelerometers, global positioning systems (GPS), pulse oximeters, ultrasonic sensors, voice-prosody analyzers, or other suitable sensors, or any combination thereof. For example, at step 1904, the system may receive (e.g., via one or more sensors) an indication of a user gesture (e.g., arm, hand, fingers, etc.). In some embodiments, at step 1906, the system determines if the user gesture corresponds to a musical pattern associated with a first instrument stem of the plurality of audio stems of the prerecorded audio performance. For example, the system may process data from the one or more sensors (e.g., by using Kalman filters, ML models, or comparing to a data structure comprising movement signatures) to determine a confidence score between the user movements and the movements of an instrument stem of the content item being played. If the confidence score is below a predetermined threshold, the system determines the user gesture does not correspond with any instrument stem of the prerecorded audio performance and reverts to step 1902. If the confidence score meets or is above a predetermined threshold, the system determines the user gesture does correspond with an instrument stem of the prerecorded audio performance and proceeds to step 1908. In some embodiments, at step 1908, the system may increase the prominence of the first instrument stem (e.g., corresponding to the user gesture) with respect to at least one second audio stem of the plurality of audio stems of the prerecorded audio performance while the prerecorded audio performance continues to be played. In some embodiments, the system continues to monitor user gesture input. For example, at step 1910, the system determines whether the user gesture stops. For example, if the system determines that the user gesture has not stopped, the system may maintain the prominence of the first stem at step 1908. For example, if the system determines that the user gesture has stopped, the process proceeds to step 1912, in which the system may restore the first instrument stem prominence to the original level and restart the process at step 1902.

FIG. 20 depicts illustrative user equipment 2000 and 2001, in accordance with some embodiments of this disclosure. User equipment 2000 and 2001 may correspond to, e.g., first device 203 of FIG. 2, second device 205 of FIG. 2, and user equipment 518 of FIG. 5. For example, user equipment 2000 may be a smartphone device, a tablet, a computer, a near-eye display device, an XR device, or any other suitable device capable of viewing and/or editing media, e.g., locally or over a communication network. In another example, user equipment 2001 may be a user television equipment system, gaming system, processor unit, computing unit, or other device. User equipment 2001 may include set-top box 2015. Set-top box 2015 may be communicatively connected to microphone 2016, audio output equipment 2014 (e.g., speaker or headphones), and display 2012. In some embodiments, microphone 2016 may receive audio corresponding to a voice of a user and/or ambient audio data. In some embodiments, display 2012 may be a television display, a computer display, a smartphone display, HMD, glasses, goggles, or any display of the aforementioned user equipment. In some embodiments, set-top box 2015 may be communicatively connected to user input interface 2010. In some embodiments, user input interface 2010 may be a remote-control device, sensors that detect user commands, or a touchscreen display. Set-top box 2015 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path (e.g., I/O path 2002). More specific implementations of user equipment are discussed below in connection with FIG. 8. In some embodiments, user equipment 2000 may comprise any suitable number of sensors (e.g., gyroscope or gyrometer, accelerometer, or camera, etc.), and/or a GPS module (e.g., in communication with one or more servers and/or cell towers and/or satellites) to ascertain a location of user equipment 2000. In some embodiments, user equipment 2000 comprises a rechargeable battery that is configured to provide power to the components of the device.

Each one of user equipment 2000 and user equipment 2001 may receive content and data via I/O path 2002. I/O path 2002 may provide content (e.g., broadcast programming, on-demand programming, internet content, content available over a local area network (LAN) or wide area network (WAN), and/or other content) and data to control circuitry 2004, which may comprise processing circuitry 2006 and storage circuitry 2008. Control circuitry 2004 may be used to send and receive commands, requests, and other suitable data using I/O path 2002, which may comprise I/O circuitry. I/O path 2002 may connect control circuitry 2004 to one or more communications paths (described below). I/O functions may be provided by one or more of these communications paths but are shown as a single path in FIG. 20 to avoid overcomplicating the drawing. While set-top box 2015 is shown in FIG. 20 for illustration, any suitable computing device having processing circuitry, control circuitry, and storage may be used in accordance with the present disclosure. For example, set-top box 2015 may be replaced by, or complemented by, a personal computer (e.g., a notebook, a laptop, a desktop, user equipment 2107 of FIG. 21, etc.), a smartphone (e.g., user equipment 2108 of FIG. 21), a television (e.g., user equipment 2110 of FIG. 21), an XR device (e.g., first device 203 of FIG. 2, second device 205 of FIG. 2, and user equipment 518 of FIG. 5, user equipment 2106 of FIG. 21, etc.), a tablet, a network-based server hosting a user-accessible client device, a non-user-owned device, any other suitable device, or any combination thereof.

Control circuitry 2004 may be based on any suitable control circuitry such as processing circuitry 2006. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i7 processor and an Intel Core i9 processor). In some embodiments, control circuitry 2004 executes instructions for the media application (as described in connection with FIGS. 1-21) stored in memory (e.g., storage circuitry 2008). Specifically, control circuitry 2004 may be instructed by the media application to perform the functions discussed above and below. In some implementations, processing or actions performed by control circuitry 2004 may be based on instructions received from the media application.

In client/server-based embodiments, control circuitry 2004 may include communications circuitry suitable for communicating with a server or other networks or servers. The media application may be a stand-alone application implemented on a device or a server. The media application may be implemented as software or a set of executable instructions. The instructions for performing any of the embodiments discussed herein of the media application may be encoded on non-transitory computer-readable media (e.g., a hard drive, random-access memory on a dynamic random-access memory (DRAM) integrated circuit, read-only memory on a BLU-RAY disk, etc.). For example, in FIG. 20, the instructions may be stored in storage circuitry 2008, and executed by control circuitry 2004 of a user equipment 2000.

In some embodiments, the media application may be a client/server application where only the client application resides on user equipment 2000, and a server application resides on an external server (e.g., server 2104 of FIG. 21 and/or media content source 2102 of FIG. 21). For example, the media application may be implemented partially as a client application on control circuitry 2004 of user equipment 2000 and partially on server 2104 as a server application running on control circuitry 2111. Server 2104 may be a part of a local area network with one or more of user equipment 2000, or may be part of a cloud computing environment accessed via the internet. In a cloud computing environment, various types of computing services for performing searches on the internet or informational databases, providing video communication capabilities, providing storage (e.g., for a database) or parsing data (e.g., using ML algorithms as describe herein) are provided by a collection of network-accessible computing and storage resources (e.g., server 2104 and/or an edge computing device), referred to as “the cloud.” User equipment 2000 may be a cloud client that relies on the cloud computing capabilities from server 2104 to determine whether processing should be offloaded from the local device, and facilitate such offloading. The client application may instruct control circuitry 2004 to generate audio adjustments for better audio matching.

Control circuitry 2004 may include communications circuitry suitable for communicating with a server, edge computing systems and devices, a table or database server, or other networks or servers. The instructions for carrying out the above mentioned functionality may be stored on a server (which is described in more detail in connection with FIG. 8). Communications circuitry may include a cable modem, an integrated services digital network (ISDN) modem, a digital subscriber line (DSL) modem, a telephone modem, an Ethernet card, or a wireless modem for communications with other equipment, or any other suitable communications circuitry. Such communications may involve the internet or any other suitable communication networks or paths (which is described in more detail in connection with FIG. 8). In addition, communications circuitry may include circuitry that enables peer-to-peer communication of user equipment, or communication of user equipment in locations remote from each other (described in more detail below).

Memory may be an electronic storage device provided as storage circuitry 2008 that is part of control circuitry 2004. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Storage circuitry 2008 may be used to store various types of content described herein as well as media application data described above. Nonvolatile memory may also be used (e.g., to launch a boot-up routine and other instructions). Cloud-based storage, described in relation to FIG. 20, may be used to supplement storage circuitry 2008 or instead of storage circuitry 2008. Non-transitory memory may store instructions that, when executed by control circuitry, I/O circuitry, any other suitable circuitry or combination thereof, executes functions of a media application as described above.

Control circuitry 2004 may include video generating circuitry and tuning circuitry, such as one or more MPEG-2 decoders or high efficiency video coding (HEVC) decoders or any other suitable digital decoding circuitry, high-definition tuners, one or more analog tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 2004 may also include scaler circuitry for upconverting and downconverting content into the preferred output format of user equipment 2000. Control circuitry 2004 may also include digital-to-analog converter circuitry and analog-to-digital converter circuitry for converting between digital and analog signals. The tuning and encoding circuitry may be used by user equipment 2000 and 2001 to receive and to display, to play, or to record content. The tuning and encoding circuitry may also be used to receive video and/or audio communication session data. The circuitry described herein, including, for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage circuitry 2008 is provided as a separate device from user equipment 2000, the tuning and encoding circuitry (including multiple tuners) may be associated with storage circuitry 2008.

Control circuitry 2004 may receive instruction from a user by way of user input interface 2010. User input interface 2010 may be any suitable user interface, such as a remote control, mouse, trackball, keypad, keyboard, touchscreen, touchpad, stylus input, joystick, voice recognition interface, sensor interface (e.g., to track body movement, eye gaze, biometric parameters, etc.), or other user input interfaces. Display 2012 may be provided as a stand-alone device or integrated with other elements of each one of user equipment 2000 and user equipment 2001. For example, display 2012 may be a touchscreen or touch-sensitive display. In such circumstances, user input interface 2010 may be integrated with or combined with display 2012. In some embodiments, user input interface 2010 includes a remote-control device having one or more microphones, buttons, keypads, sensors, or any other components configured to receive user input or combinations thereof. For example, user input interface 2010 may include a handheld remote-control device having an alphanumeric keypad and option buttons. In a further example, user input interface 2010 may include a handheld remote-control device having a microphone and control circuitry configured to receive and identify voice commands and transmit information to set-top box 2015.

Audio output equipment 2014 may be integrated with or combined with display 2012, and/or an HMD. Display 2012 may be one or more of a monitor, television, liquid crystal display (LCD) for an HMD, mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, projection, or any other suitable equipment for displaying visual images. A video card or graphics card may generate the output to the display 2012. Audio output equipment 2014 may be provided as integrated with other elements of each one of user equipment 2000 and user equipment 2001 or may be stand-alone units. An audio component of videos and other content displayed on display 2012 may be played through speakers (or headphones) of audio output equipment 2014. In some embodiments, audio may be distributed to a receiver (not shown), which processes and outputs the audio via speakers of audio output equipment 2014. In some embodiments, for example, control circuitry 2004 is configured to provide audio cues to a user, or other audio feedback to a user, using speakers of audio output equipment 2014. There may be a separate microphone 2016 or audio output equipment 2014 may include a microphone configured to receive audio input such as voice commands or speech. For example, a user may speak letters or words that are received by the microphone and converted to text by control circuitry 2004. In a further example, a user may provide voice commands that are received by a microphone and recognized by control circuitry 2004. Camera 2018 may be any suitable video camera integrated with the equipment or externally connected. Camera 2018 may be a digital camera comprising a charge-coupled device (CCD) and/or a complementary metal-oxide semiconductor (CMOS) image sensor. Camera 2018 may be an analog camera that converts to digital images via a video card.

The media application may be implemented using any suitable architecture. For example, it may be a stand-alone application wholly implemented on each one of user equipment 2000 and user equipment 2001. In such an approach, instructions of the application may be stored locally (e.g., in storage circuitry 2008), and data for use by the application is downloaded on a periodic basis (e.g., from an out-of-band feed, from an internet resource, or using another suitable approach). Control circuitry 2004 may retrieve instructions of the application from storage circuitry 2008 and process the instructions to provide video conferencing functionality and generate any of the displays discussed herein. Based on the processed instructions, control circuitry 2004 may determine what action to perform when input is received from user input interface 2010. For example, movement of a cursor or selection field on a display up/down may be indicated by the processed instructions when user input interface 2010 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, random access memory (RAM), flash drives, NVMe, NAS, etc.

Control circuitry 2004 may allow a user to provide user profile information or may automatically compile user profile information. For example, control circuitry 2004 may access and monitor network data, video data, audio data, processing data, content consumption data, and/or any other suitable data being accessed by a user. Control circuitry 2004 may obtain all or part of other user profiles that are related to a particular user (e.g., via social media networks), and/or obtain information about the user from other sources that control circuitry 2004 may access. As a result, a user can be provided with a unified experience across the user's different devices.

In some embodiments, the media application is a client/server-based application. Data for use by a thick or thin client implemented on each one of user equipment 2000 and user equipment 2001 may be retrieved on demand by issuing requests to a server remote to each one of user equipment 2000 and user equipment 2001. For example, the remote server may store the instructions for the application in a storage device. The remote server may process the stored instructions using circuitry (e.g., control circuitry 2004) and generate the displays discussed above and below. The client device may receive the displays generated by the remote server and may display the content of the displays locally on user equipment 2000. This way, the processing of the instructions is performed remotely by the server while the resulting displays (e.g., that may include text, a keyboard, or other visuals) are provided locally on user equipment 2000. User equipment 2000 may receive inputs from the user via user input interface 2010 and transmit those inputs to the remote server for processing and generating the corresponding displays. For example, user equipment 2000 may transmit a communication to the remote server indicating that an up/down button was selected via user input interface 2010. The remote server may process instructions in accordance with that input and generate a display of the application corresponding to the input (e.g., a display that moves a cursor up/down). The generated display is then transmitted to user equipment 2000 for presentation to the user.

In some embodiments, the media application may be downloaded and interpreted or otherwise run by an interpreter or virtual machine (e.g., run by control circuitry 2004). In some embodiments, the media application may be encoded in the ETV Binary Interchange Format (EBIF), received by control circuitry 2004 as part of a suitable feed, and interpreted by a user agent running on control circuitry 2004. For example, the media application may be an EBIF application. In some embodiments, the media application may be defined by a series of JAVA-based files that are received and run by a local virtual machine or other suitable middleware executed by control circuitry 2004. In some of such embodiments (e.g., those employing MPEG-2, MPEG-4, HEVC or any other suitable digital media encoding schemes), the media application may be, for example, encoded and transmitted in an MPEG-2 object carousel with the MPEG audio and video packets of a program.

FIG. 21 depicts an illustrative user equipment system 2100, in accordance with some embodiments of this disclosure. User equipment 2106, 2107, 2108, or 2110 (which may correspond to first device 203 of FIG. 2, second device 205 of FIG. 2, and user equipment 518 of FIG. 5) may be coupled to communication network 2109. Communication network 2109 may be one or more networks including the internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 2109) may separately or together include one or more communications paths, such as a satellite path, a fiber-optic path, a cable path, a path that supports internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 21 to avoid overcomplicating the drawing.

Although communications paths are not drawn between user equipment, these devices may communicate directly with each other via communications paths as well as other short-range, point-to-point communications paths, such as USB cables, IEEE 1394 cables, wireless paths (e.g., Bluetooth, infrared, IEEE 802-11x, etc.), or other short-range communication via wired or wireless paths. The user equipment may also communicate with each other directly through an indirect path via communication network 2109.

System 2100 may comprise media content source 2102, one or more servers 2104, and/or one or more edge computing devices 2116 (e.g., included as part of an edge computing system). In some embodiments, the media application may be executed at one or more of control circuitry 2111 of server 2104 (and/or control circuitry of user equipment 2106, 2107, 2108, 2110 and/or control circuitry 2118 of edge computing device 2116). In some embodiments, the media content source and/or server 2102 may be configured to host or otherwise facilitate video and/or audio communication sessions between user equipment 2106, 2107, 2108, 2110 and/or any other suitable user equipment, and/or host or otherwise be in communication (e.g., over communication network 2109) with one or more streaming services.

In some embodiments, server 2104 may include control circuitry 2111 and storage circuitry 2114 (e.g., RAM, ROM, Hard Disk, Removable Disk, etc.). Storage 2114 may store one or more databases. Server 2104 may also include an I/O path 2112. In some embodiments, I/O path 2112 is an I/O circuitry. I/O circuitry may be a NIC card, audio output device, mouse, keyboard card, voice recognition interface, sensor interface, any other suitable I/O circuitry device or combination thereof. I/O path 2112 may provide video conferencing data, device information, or other data, over a local area network (LAN) or wide area network (WAN), and/or other content and data to control circuitry 2111, which may include processing circuitry, and storage circuitry 2114. Control circuitry 2111 may be used to send and receive commands, requests, and other suitable data using I/O path 2112, which may comprise I/O circuitry. I/O path 2112 may connect control circuitry 2111 to one or more communications paths.

Control circuitry 2111 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 2111 may be distributed across multiple separate processors or processing units, for example, multiple of the same type of processing units (e.g., two Intel Core i7 processors) or multiple different processors (e.g., an Intel Core i7 processor and an Intel Core i9 processor). In some embodiments, control circuitry 2111 executes instructions for an emulation system application stored in memory (e.g., the storage circuitry 2114). Memory may be an electronic storage device provided as storage circuitry 2114 that is part of control circuitry 2111. Memory may store instruction to run the media application.

Edge computing device 2116 may comprise control circuitry 2118, I/O path 2120 and storage 2122, which may be implemented in a similar manner as control circuitry 2111, I/O path 2112 and storage 2114, respectively of server 2104. Edge computing device 2116 may be configured to be in communication with one or more of user equipment devices 2106, 2107, 2108, 2110, content source 2102, and server 2104 over communication network 2109, and may be configured to perform processing tasks in connection with ongoing processing of content item data. In some embodiments, a plurality of edge computing devices 2116 may be strategically located at various geographic locations, and may be mobile edge computing devices configured to provide processing support for mobile devices at various geographical regions.

The term “and/or,” may be understood to mean “either or both” of the elements thus indicated. Additional elements may optionally be present unless excluded by the context. Terms such as “first,” “second,” or “third” in the claims referring to a structure, module or step should not necessarily be construed to mean precedence or temporal order but are generally intended to distinguish between claim elements.

Unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The above-described embodiments are intended to be examples only. Components or processes described as separate may be combined or combined in ways other than as described, and components or processes described as being together or as integrated may be provided separately. Steps or processes described as being performed in a particular order may be re-ordered or recombined.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

Any use of a phrase such as “in some embodiments” or the like with reference to a feature is not intended to link the feature to another feature described using the same or a similar phrase. Any and all embodiments disclosed herein are combinable or separately practiced as appropriate. Absence of the phrase “in some embodiments” does not imply that the feature is necessary. Inclusion of the phrase “in some embodiments” does not imply that the feature is not applicable to other embodiments or even all embodiments.

Features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time.

The systems and/or methods described above may be applied to, or used in accordance with, other systems and/or methods. In various embodiments, additional elements may be included, some elements may be removed, and/or elements may be arranged differently from what is shown. Alterations, modifications, combination, and variations may be effected to the particular embodiments by those of skill in the art without departing from the scope of the present application, which is defined solely by the claims appended hereto. Throughout the specification, the phrases “in response to” and “based on” shall be understood to have a broad meaning unless context requires otherwise. For example, “in response to” may refer to a step that is in direct or indirect response to a prior step, and “based on” may refer to a step that is based at least in part on a prior step or on another factor.

1. A method comprising:
receiving user voice data while a prerecorded audio performance comprising a plurality of audio stems is being played;
determining that the user voice data corresponds to a vocal stem of the plurality of audio stems of the prerecorded audio performance; and
based at least in part on the determining that the user voice data corresponds to the vocal stem of the prerecorded audio performance, causing modification of the play of the prerecorded audio performance and causing play of audio based on the user voice data.

2. The method of claim 1, wherein the determining that the user voice data corresponds to the vocal stem of the prerecorded audio performance comprises:
retrieving metadata associated with the prerecorded audio performance; and
determining that speech data detected based at least in part on the user voice data corresponds to a lyrics data set of the metadata associated with the prerecorded audio performance.

3. The method of claim 1, wherein the determining that the user voice data corresponds to the vocal stem of the prerecorded audio performance comprises:
retrieving metadata associated with the prerecorded audio performance; and
determining that one or more of pitch data, beat data, or tempo data detected based at least in part on the user voice data corresponds to a data set of the metadata associated with the prerecorded audio performance.

4. The method of claim 1, wherein the modification comprises adjusting output of two or more instrument stems of the plurality of audio stems of the prerecorded audio performance being played such that the audio based on the user voice data is caused to be played spatially centered between the two or more instrument stems of the prerecorded audio performance.

5. The method of claim 1, wherein the modification comprises adjusting sound spatialization of instrumental stems of the plurality of audio stems of the prerecorded audio performance.

6. The method of claim 1, wherein the modification comprises reducing a volume of the vocal stem of the prerecorded audio performance.

7. The method of claim 6, further comprising:
determining cessation of receipt of the user voice data while the prerecorded audio performance is being played with the modification; and
based at least in part on the determining the cessation of the receipt of the user voice data, increasing the volume of the vocal stem of the prerecorded audio performance while other audio stems of the plurality of audio stems of the prerecorded audio performance continue to be played.

8. The method of claim 1, wherein the causing the modification of the play of the prerecorded audio performance and the causing the play of the audio based on the user voice data is caused at a first device, and
simultaneously causing play of the prerecorded audio performance without the modification of the play of the prerecorded audio performance and the play of the audio based on the user voice data at a second device.

9. The method of claim 1, further comprising:
receiving a graphical user interface request for adjusting at least one of a spatial arrangement of an instrument stem of the prerecorded audio performance, a volume of the instrument stem of the prerecorded audio performance, or an audio effect for the instrument stem of the prerecorded audio performance; and
causing modification of the play of the prerecorded audio performance based at least in part on the adjusting.

10. The method of claim 1, further comprising:
receiving an initiation command, wherein the determining that the user voice data corresponds to the vocal stem of the plurality of audio stems of the prerecorded audio performance is performed based at least in part on the receiving the initiation command.

11. A method comprising:
receiving an indication of a user arm gesture while a prerecorded audio performance comprising a plurality of audio stems is being played;
determining that the indication of the user arm gesture corresponds to a musical pattern associated with a first instrument stem of the plurality of audio stems of the prerecorded audio performance; and
based at least in part on the determining that the indication of the user arm gesture corresponds to the musical pattern associated with the first instrument stem, causing an increase in prominence of output of the first instrument stem with respect to at least one second audio stem of the plurality of audio stems of the prerecorded audio performance.

12. The method of claim 11, further comprising:
based at least in part on determining that the indication of the user arm gesture is no longer being detected, causing restoring of output of the first instrument stem to a setting before the causing of the increase in prominence of the first instrument stem while the prerecorded audio performance continues to be played.

13. The method of claim 11, wherein the determining that the indication of the user arm gesture corresponds to the first instrument stem comprises:
determining that the indication of the user arm gesture corresponds to one of an air guitar gesture profile, an air drum gesture profile, an air saxophone gesture profile, or an air trumpet gesture profile.

14. The method of claim 11, further comprising:
adjusting a spatial arrangement of a second audio stem and a third audio stem of the plurality of audio stems of the prerecorded audio performance such that output of the first instrument stem is caused to be played spatially centered between the second audio stem and the third audio stem.

15. A system comprising:
memory;
input/output circuitry configured to:
receive user voice data while a prerecorded audio performance comprising a plurality of audio stems is being played; and
control circuitry configured to:
determine that the user voice data corresponds to a vocal stem of the plurality of audio stems of the prerecorded audio performance; and
based at least in part on the determining that the user voice data corresponds to the vocal stem of the prerecorded audio performance, cause modification of the play of the prerecorded audio performance and cause play of audio based on the user voice data.

16. The system of claim 15, wherein the control circuitry configured to determine that the user voice data corresponds to the vocal stem of the prerecorded audio performance is further configured to:
retrieve metadata associated with the prerecorded audio performance; and
determine that speech data detected based at least in part on the user voice data corresponds to a lyrics data set of the metadata associated with the prerecorded audio performance.

17. The system of claim 15, wherein the control circuitry configured to determine that the user voice data corresponds to the vocal stem of the prerecorded audio performance is further configured to:
retrieve metadata associated with the prerecorded audio performance; and
determine that one or more of pitch data, beat data, or tempo data detected based at least in part on the user voice data corresponds to a data set of the metadata associated with the prerecorded audio performance.

18. The system of claim 15, wherein the modification comprises adjusting output of two or more instrument stems of the plurality of audio stems of the prerecorded audio performance being played such that the audio based on the user voice data is caused to be played spatially centered between the two or more instrument stems of the prerecorded audio performance.

19. The system of claim 15, wherein the modification comprises adjusting sound spatialization of instrumental stems of the plurality of audio stems of the prerecorded audio performance.

20. The system of claim 15, wherein the modification comprises reducing a volume of the vocal stem of the prerecorded audio performance.

21-70. (canceled)
